(19) United States
(12) Patent Application Publication
(10) Pub. No.: US 2026/0135363 A1
(43) Pub. Date: May 14, 2026

(54) OPEN BACK BOX AND ADJUSTABLE MOUNTING BRACKET

(71) Applicant: ERICO International Corporation, Solon, OH (US)

(72) Inventors: Matthew William Sweeney, Ringwood, IL (US); James Anthony Bukowski, Akron, OH (US); Jody Seubert, Appleton, WI (US)

(21) Appl. No.: 19/388,779

(22) Filed: Nov. 13, 2025

Related U.S. Application Data
(60) Provisional application No. 63/720,074, filed on Nov. 13, 2024.

(51) Int. Cl. H02G 3/12

(52) U.S. Cl. CPC H02G 3/12

(57) ABSTRACT

A method of installing an electrical assembly to a wall stud includes providing an electrical assembly with a junction box, a mounting bracket, and an electrical device secured to the junction box. The mounting bracket is selectively secured to extend along either a first side or a second side of the wall stud. Without removing the electrical device from the junction box, the junction box is selectively supported on the mounting bracket with the electrical device slidingly engaged with either side of the junction box. The depth of the junction box relative to the mounting bracket is adjustable. The mounting bracket includes an anchor wall that engages the opposite side of the wall stud and an adjustment wall for sliding engagement and depth adjustment. The system includes an open back for electrical connection that can be closed with a back cover.

### CROSS-REFERENCE TO RELATED APPLICATION

This application claims the benefit of U.S. Provisional Application No. 63/720,074 filed on November 13, 2024, the entire content of which is incorporated herein by reference.

### BACKGROUND

An electrical box or junction box is configured to accommodate a power socket or other electrical devices. The junction box commonly cooperates with a mounting bracket and is fixed on a stud wall via the mounting bracket.

### SUMMARY

According to one aspect of the present disclosure, a method of installing an electrical assembly to a wall stud is provided. The wall stud can define a front face, a rear face, a first side extending between the front face and the rear face, and a second side extending between the front face and the rear face. The method can include providing the electrical assembly, including a junction box, a mounting bracket, and an electrical device secured to the junction box in a first orientation. The junction box can define a front, a rear, a top, a bottom, a first side extending from the front to the rear between the top and the bottom, and a second side extending from the front to the rear between the top and the bottom. The method can include selectively securing the mounting bracket to extend along either the first side of the wall stud or the second side of the wall stud. The method can include, with the electrical device in the first orientation and without removing the electrical device from the junction box, selectively supporting the junction box on the mounting bracket with the electrical device slidingly engaged with the first side of the junction box, along the first side of the wall stud, with the mounting bracket secured to extend along the first side of the wall stud, or the second side of the junction box, along the second side of the wall stud, with the mounting bracket secured to extend along the second side of the wall stud. The method can include adjusting a depth of the junction box relative to the mounting bracket to adjust a depth of junction box and the electrical device relative to the wall stud.

In some examples, the method may further include, after selectively securing of the mounting bracket to extend along the first side of the wall stud or the second side of the wall stud, after selectively supporting the junction box on the mounting bracket along the first side of the wall stud or the second side of the wall stud, and without removing the electrical device from the junction box, slidably disengaging the junction box from the mounting bracket at the first side of the junction box or at the second side of the junction box, respectively. The method may include securing the mounting bracket to extend along the second side of the wall stud or the first side of the wall stud, respectively. The method may include, with the electrical device in the first orientation, slidably engaging the junction box to the mounting bracket at, respectively, the second side of the junction box, along the second side of the wall stud, or the first side of the junction box, along the first side of the wall stud.

In some examples, the junction box may include an open back and a back cover that can be removably or hingedly coupled to the junction box to cover the open back. The method may further include connecting an electrical device of the electrical assembly to a building electrical system by accessing the electrical device through an open back of the junction box. The method may include, after connecting the electrical device to the building electrical system, closing the open back with a back cover.

In some examples, selectively securing the mounting bracket to extend along the first side of the wall stud or the second side of the wall stud may include urging the mounting bracket into engagement with the wall stud so that an anchor wall of the mounting bracket can engage an opposite side of the wall stud from the junction box, and an adjustment wall of the mounting bracket can extend along the same side of the wall stud as the junction box, with the adjustment wall slidably engaging the junction box.

In some examples, the anchor wall may be shorter than the adjustment wall and may include a barb that can be configured to engage the wall stud.

In some examples, adjusting the depth of the junction box relative to the mounting bracket may include rotating an adjustment screw that can engage threads on the adjustment wall of the mounting bracket.

In some examples, the threads may be defined by slots formed in the adjustment wall.

In some examples, the adjustment screw may include a head that can be retained by a snap-engagement relative to the junction box.

According to another aspect of the present disclosure, a method of installing an electrical assembly to a wall stud is provided. The method can include accessing the electrical assembly including a mounting bracket secured to a wall stud in a first orientation, a junction box secured to the mounting bracket along a first side of a wall stud, and an electrical device secured to the junction box in a first orientation. The junction box can include a first side, and a second side opposite the first side. The method can include, without removing the electrical device from the junction box and without reorienting the electrical device relative to the junction box, removing the junction box from the mounting bracket, removing the mounting bracket from the wall stud, reattaching the mounting bracket to the wall stud in a second orientation, different from the first orientation, and installing the junction box to the mounting bracket, with the electrical device in the first orientation on a second side of the wall stud opposite the first side. The method can include, after installing the junction box to the mounting bracket with the electrical device on the second side of the wall stud, adjusting a depth of the junction box relative to the mounting bracket to adjust a depth of the junction box and the electrical device relative to the wall stud.

In some examples, the method may further include, after installing the junction box to the mounting bracket with the electrical device on the second side of the wall stud, accessing the electrical device through an open back of the junction box to connect the electrical device to a building electrical system.

In some examples, the method may further include closing the open back with a back cover, after connecting the electrical device to the building electrical system.

In some examples, adjusting the depth of the junction box may include adjusting a screw that can be retained on the junction box to engage a set of angled slots on the mounting bracket.

In some examples, the back cover may be a hinged cover, and closing the open back may include rotating the back cover to a closed orientation.

According to yet another aspect of the present disclosure, an electrical assembly for a wall stud is provided. The electrical assembly can include a junction box having an open back and defining a front, a rear, a top, a bottom, a first side extending from the front to the rear between the top and the bottom, and a second side extending from the front to the rear between the top and the bottom. The electrical assembly can include an electrical device secured to the junction box in a first orientation. The electrical assembly can include a mounting bracket that can be selectively securable to the wall stud to extend along a first side of the wall stud or a second side of the wall stud, to selectively support the junction box at the first side of the junction box or the second side of the junction box, with the junction box selectively on a first side of a wall stud or a second side of the wall stud, respectively, the electrical device in the first orientation, and the mounting bracket slidingly engaged with the junction box for depth adjustment of the junction box relative to the mounting bracket to adjust a depth of junction box and the electrical device relative to the wall stud.

In some examples, the junction box may include first grooves on the first side and second grooves on the second side that can be selectively engageable by the mounting bracket to mount the junction box on the first side of the wall stud or the second side of the wall stud, respectively, without removal or reorientation of the electrical device relative to the junction box.

In some examples, the first grooves may include a first upper groove and a first lower groove and the second grooves may include a second upper groove and a second lower groove. The mounting bracket may include a plurality of first tabs and a plurality of second tabs. To slidingly support the junction box on the first side of the wall stud, the plurality of first tabs may be receivable in the first upper groove and the plurality of second tabs may be receivable in the first lower groove. To slidingly support the junction box on the second side of the wall stud, the plurality of first tabs may be receivable in the second lower groove and plurality of second tabs may be receivable in the second upper groove.

In some examples, the electrical assembly may further include a threaded fastener that can be engageable with threaded features on the mounting bracket to adjust the depth of the junction box.

In some examples, the threaded features may include angled slots.

In some examples, the electrical assembly may further include a removable back cover that can be configured to cover an open back of the junction box.

In some examples, the removable back cover may be hingedly coupled to the junction box with one or more hinge clips secured to the junction box.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a front axonometric view of an electrical assembly according to an embodiment of the invention, with a junction box and the mounting bracket installed on a left side of the junction box in an assembled configuration;

FIG. 2 is a rear axonometric view of the electrical assembly without a back cover of FIG. 1;

FIG. 3A is a front axonometric view of the mounting bracket of FIG. 1;

FIG. 3B is a side axonometric view of the mounting bracket of FIG. 1;

FIG. 4 is a rear axonometric view of the back cover of FIG. 1;

FIG. 5A is a rear axonometric view of the electrical assembly of FIG. 1 with the back cover in a staged configuration for installation or removal;

FIG. 5B is a rear, right, top axonometric view of the electrical assembly of FIG. 1, with the back cover in a closed configuration;

FIG. 6A is an enlarged axonometric view of area VIA of FIG. 5A from within the junction box;

FIG. 6B is an enlarged axonometric view of area VIB of FIG. 5B from within the junction box;

FIG. 7 is a front elevation view of the mounting assembly of FIG. 1 in an installed configuration with the back cover in a closed configuration;

FIG. 8A is an enlarged view of area VIII of FIG. 7 with the back cover in the open configuration;

FIG. 8B is an enlarged view of area VIII of FIG. 7 with the back cover in the closed configuration;

FIG. 9 is an enlarged view of area IX of FIG. 7;

FIG. 10 is a front axonometric view of the electrical assembly of FIG. 1 with an outlet installed;

FIG. 11 is a front axonometric view of the electrical assembly of FIG. 1 secured to a first side of a wall stud;

FIG. 12 is a front axonometric view of the electrical assembly of FIG. 1 with the mounting bracket arranged for installation on a second side of the wall stud of FIG. 11;

FIG. 13 is a front axonometric view of an electrical assembly according to another embodiment of the invention;

FIG. 14A is a front elevation view of the electrical assembly of FIG. 13

FIG. 14B is a rear elevation view of the electrical assembly of FIG. 13;

FIG. 15 is a front view of an electrical assembly according to another embodiment of the invention, with the electrical assembly being installed on a right side wall of a wall stud;

FIG. 16A is a front view of a mounting bracket for use in the electrical assembly of FIG. 15;

FIG. 16B is an enlarged view of area XVIB of FIG. 16A;

FIG. 17 is a left axonometric view of the mounting bracket of FIG. 16A;

FIG. 18A is a front view of a junction box for use in the electrical assembly of FIG. 15;

FIG. 18B is a rear view of the junction box of FIG. 18A;

FIG. 19A is an enlarged view of area XVIXA of FIG. 18A;

FIG. 19B is an enlarged view of area XVIXA of FIG. 18A with a screw installed;

FIG. 20 is an enlarged view of area XX of FIG. 18A;

FIG. 21 is a front axonometric view of an electrical assembly according to another embodiment of the invention;

FIG. 22A is a right axonometric view of a mounting bracket for use in the electrical assembly of FIG. 21, with the electrical assembly being installed on a right side wall of a wall stud;

FIG. 22B is a left axonometric view of the mounting bracket of FIG. 22A;

FIG. 23 is a front view of a junction box for use in the electrical assembly of FIG. 21;

FIG. 24A is a front view of a cover for use in the electrical assembly of FIG. 21;

FIG. 24B is a rear view of the cover of FIG. 24A;

FIG. 25 is a front view of a clip for use in the electrical assembly of FIG. 21;

FIG. 26A is a front axonometric view of a key for use in the electrical assembly of FIG. 21;

FIG. 26B is a front left axonometric view of the key of FIG. 26A;

FIG. 27A is a rear left side axonometric view of the electrical assembly of FIG. 21 with the cover in the open position;

FIG. 27B is a rear left side axonometric view of the electrical assembly of FIG. 21 with the cover in the open position with the junction box being transparent;

FIG. 28A is a front view of the electrical assembly of FIG. 21 with the cover in the closed position;

FIG. 28B is a rear view of the electrical assembly of FIG. 21 with the cover in the closed position; and

FIG. 29 is a left front axonometric view of the electrical assembly of FIG. 21 installed on a left side wall of the wall stud.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

In different contexts, it may be useful to support a mounting assembly relative to a wall stud. For example, the mounting assembly may include a mounting bracket secured to a junction box that houses an electrical device that connects to a power source (e.g., an outlet, a switch, a data port, etc.). In conventional designs, however, the mounting bracket can only be conveniently installed on one side of the junction box (e.g., may require time-consuming dis- and re-assembly to switch between stud sides). Further, adjustability of a depth of junction boxes may be cumbersome or otherwise limited. Moreover, particularly for composite boxes, conventional designs may not allow for easy (or any) access to the interior of the junction box once an electrical device has been installed. This may impede implementation of prefabrication processes or otherwise reduce efficiency of installation on a job site.

In some cases, it may be useful to install the junction box and the mounting bracket on either a left or a right side of the wall stud. Furthermore, it may also be beneficial to adjust the depth of the junction box relative to the wall stud before, during, or after installation of drywall. It may also be useful to access the electrical device from within the junction box, including to electrically couple the electrical device to a power source (e.g., prior to the installation of drywall).

Examples of the disclosed technology can address these or other issues. For example, some mounting assemblies discussed herein can include a mounting bracket that may be removably coupled and installed on either side of the junction box, and junction boxes with corresponding features for improved adjustability and flexibility of installation. In some examples, a junction box may include a removable back cover that allows access to an interior area of the junction box (e.g., to access a back side of an electrical device already secured to the junction box). Thus, some examples of the disclosed technology can adaptably support a junction box on either side of a stud without (e.g., requiring inversion of the box and electrical devices secured thereto), can allow for improved overall security and adjustability of support for junction boxes, can provide improved overall box strength, or can provide various other benefits, as further detailed below.

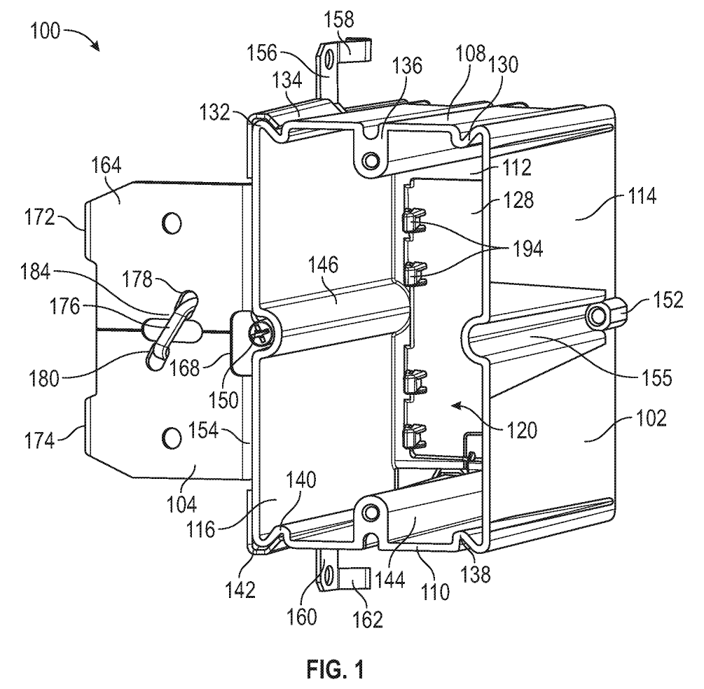

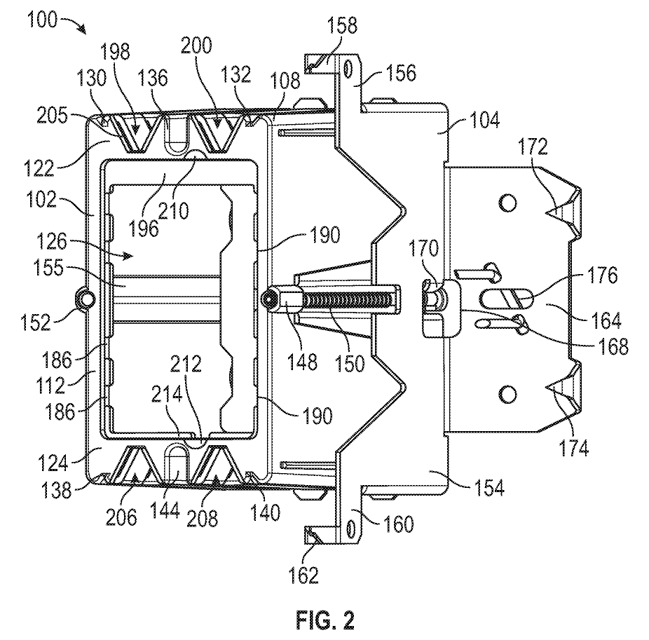

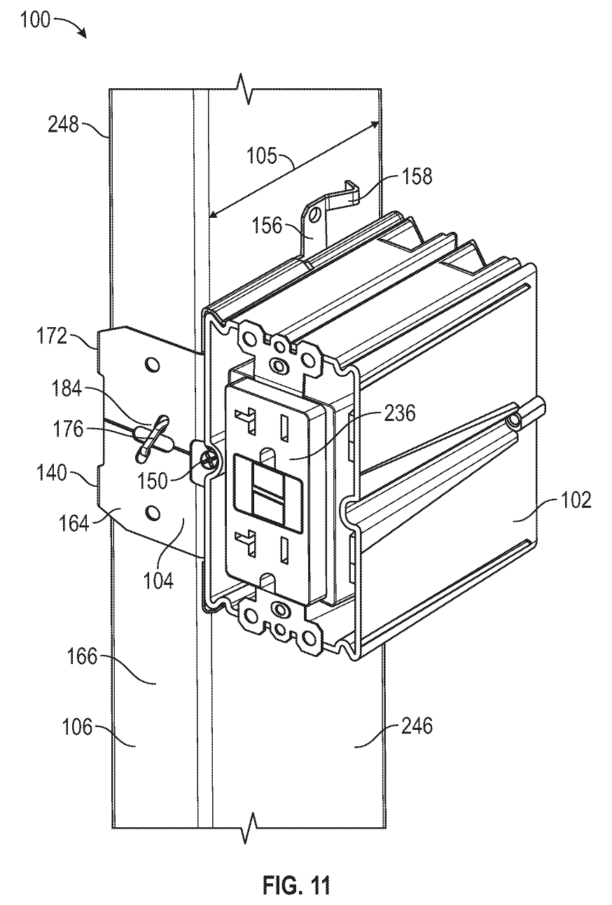

FIGS. 1 and 2 illustrate an electrical assembly 100 according to one embodiment of the invention. Generally, the electrical assembly 100 includes a junction box 102 and a mounting bracket 104 that is removably coupled to the junction box 102. In particular, as further detailed below, the mounting bracket 104 can secure the electrical assembly 100 to a wall stud 106 (not shown in FIGS. 1 and 2, but see, e.g. FIG. 11), to allow for depth adjustment of the junction box 102 relative to the wall stud 106. In some implementations, the junction box 102 may be an integrally formed box (aside from a removable cover, as detailed below), and can be formed from composite materials (e.g., PVC or other suitable plastics). For example, in some embodiments, the junction box 102 may be formed of a glass-filled polycarbonate in particular.

In the illustrated example, the junction box 102 generally has a rectangular prism shape with a top wall 108, a bottom wall 110, a back wall 112, a right side wall 114, and a left side wall 116. The junction box 102 is symmetrical about a vertical and a horizontal centerline plane in the illustrated example. Accordingly, discussion or illustration of a particular side or side-specific feature of the junction box 102 should be understood to apply equally to the opposing side or side-specific feature. Thus, for example, collective discussion or illustration of the right side wall 114 should be understood to indicate a symmetrically reflected orientation and operation the left side wall 116 relative to the other, as with other similarly co-numbered components. Correspondingly, for example, collective discussion or illustration of the top wall 108 should be understood to indicate a symmetrically reflected orientation and operation the bottom wall 110 relative to the other, as with other similarly co-numbered components. However, other examples may include non-symmetrical configurations.

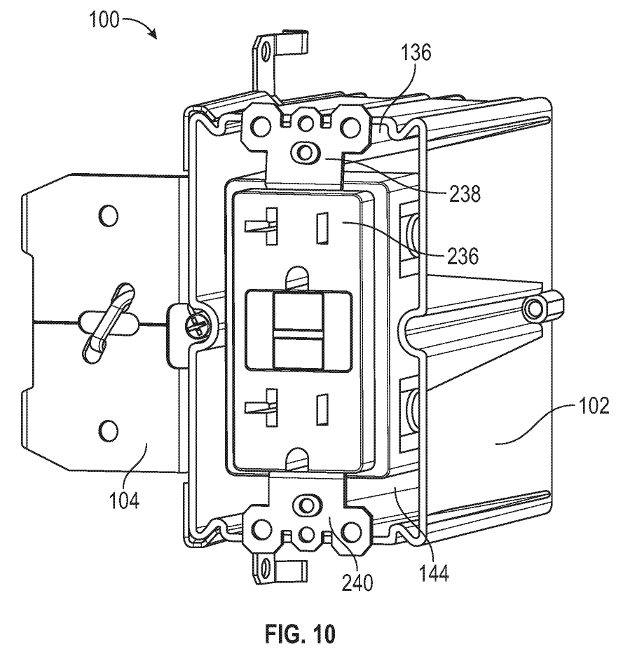

Enclosed within the top wall 108, the bottom wall 110, the back wall 112, the right side wall 114, and the left side wall 116 is a holding area 120 configured to house an electrical device (e.g., an outlet 236) (see FIG. 10). As shown in FIG. 2, the back wall 112 includes a top portion 122 located closer to the top wall 108, a bottom portion 124 located closer to the bottom wall 110, and a rear opening 126 extending between the top portion 122 and the bottom portion 124. As shown in FIG. 1, and further discussed below, a back cover 128 is removably coupled to the junction box 102 to extend across the rear opening 126 in the back wall 112.

Generally, the junction box 102 can include sets of multiple grooves on the top and bottom walls 108, 110 to allow sliding engagement with a support bracket and corresponding adjustment of a depth of the junction box 102 relative to a stud. In the illustrated example, The top wall 108 has an upper right groove 130 and an upper left groove 132. In particular, the grooves 130, 132 extend in a front to back direction across an entire depth of the junction box 102. As further detailed below, the grooves 130, 132 can selectively receive an upper arm 134 of the mounting bracket 104 for depth adjustment of the box 102 in an installed configuration.

Similar to the top wall 108, the bottom wall 110 has a lower right groove 138 and a lower left groove 140. In particular, the grooves 138, 140 also extend in the front to back direction across the entire depth of the junction box 102. Also as further detailed below, the grooves 138, 140 can selectively receive a lower arm 142 of the mounting bracket 104 for depth adjustment of the box 102 in the installed configuration.

Being integrally formed with the walls of the junction box 102 (e.g., as N-shaped bends), the grooves 130, 132, 138, 140 extend somewhat into the holding area 120. Extending between the upper grooves 130, 132 and between the lower grooves 138, 140, respectively, are upper and lower support structures 136, 144, which also protrude into the holding area 120 to secure an electrical device (e.g., an outlet) within the junction box 102. As well as providing useful adjustment and support functionality, as further detailed below, this configuration can allow for a relatively compact box profile while also providing significant strength relative to front-to-back compression of the box 102 (e.g., for certification testing).

To allow for adjustment of the junction box 102, the left side wall 116 has a left side channel 146 extending in the front to back direction across the junction box 102. Further, a threaded structure 148 (see FIG. 2) protrudes into the channel 146, adjacent to the back wall 112 of the junction box 102 (e.g., integrally with the wall 116). In the illustrated embodiment, the threaded structure 148 is configured as a cylindrical boss that is axially aligned along the left side channel 146, although other configurations are possible. Accordingly, as shown in FIGS. 1 and 2, the left side channel 146 and the threaded structure 148 can receive a screw 150 (or other threaded fastener) for depth adjustment of the junction box 102 (e.g., along arrow 105, see FIG. 11). In the illustrated embodiment, the screw 150 is positioned and received within the left side channel 146, resulting in the mounting bracket 104 being secured on the left side of the junction box 102. The right side wall 114 also has a right side channel 155 and a threaded structure 152 adjacent to the back wall 112, with similar features and benefits as the left side channel 146. Accordingly, the screw 150 can be alternatively received by the channel 155 and the threaded structure 152 (with the bracket 104 on an opposite side of the junction box 102).

Similar to the grooves 130, 132, 138, 140 and the support structures 136, 144, the channels 146, 155 are integrally formed with the walls of the junction box 102 and protrude inwardly into the holding area 120. Accordingly, for example, the relatively small exterior profile provided by this inwardly protruding configuration can allow the junction box 102 to be secured at a relatively small distance from the wall stud 106 when installed as compared with conventional designs (see, e.g., FIG. 11).

As noted above, the junction box 102 may advantageously be made out of a composite material (e.g., PVC, polycarbonate, or other types of plastic). For example, in some embodiments, the junction box 102 may be formed of a glass-filled polycarbonate in particular. Generally, a junction box formed out of plastic material may be cheaper and lighter in weight than conventional metal boxes. Further, the particular structures provided in some embodiments disclosed herein can be particularly suitable for the use of composite materials. For example, as also noted above, the inclusion of multiple grooves on top and bottom sides of an electrical box can not only allow for adaptable installation (e.g., on either opposing side of a stud) but also significantly increase overall structural strength, including as may compensate for otherwise reduced relative strength of plastic materials (e.g., as compared to metal).

Referring in particular to FIG. 2, the mounting bracket 104 includes a side wall (or adjustment wall) 154 that can seat (and slide) against the left side wall 116 or the right side wall 114 of the junction box 102 in the installed configuration (e.g., along exterior ribs of the side wall 114). As shown in FIG. 1, the upper and lower arms 134, 142 extend from opposite edges of the side wall 154 to slidably engage with the corresponding sets of grooves 132, 140 or 130, 138.

Still referring to FIG. 2, an upper flange 156 extends from the side wall 154, adjacent the upper arm 134. An upper barb 158 supported on the flange 156 can be hammered into a side of a wall stud to further secures the mounting bracket 104 with the wall stud, as will be further discussed below (see, e.g., FIG. 11). A lower flange 160 also extends from the side wall 154, adjacent the lower arm 142, to support a lower barb 162. The lower flange 160 and the lower barb 162 function similarly and offer the same benefits as discussed above with respect to the upper flange 156 and the upper barb 158, respectively.

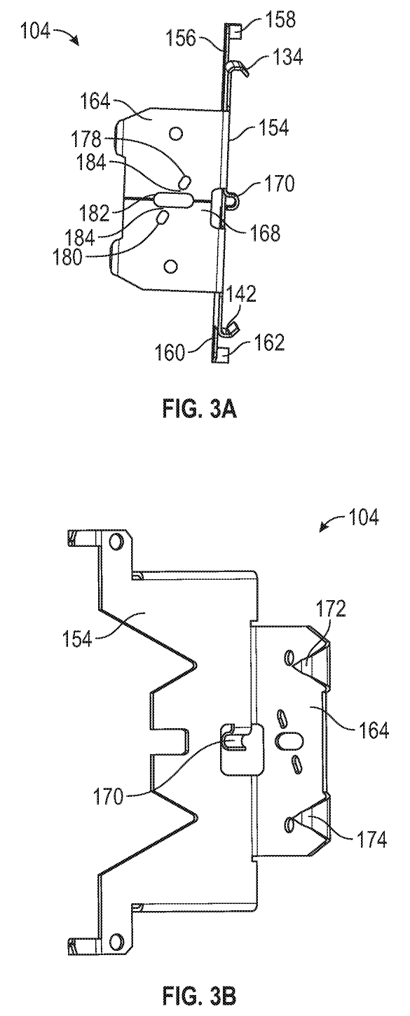

Referring now to FIG. 3A, a front wall 164 extends perpendicular to the side wall 154 and mounts the electrical assembly 100 to the wall stud 106. For example, in an installed configuration as shown in FIG. 11, the front wall 164 can seat on a front wall 166 of the wall stud 106.

Further shown in FIG. 3A, the front wall 164 defines an access opening 168 that can receive the screw 150 as installed in the left side channel 146 or the right side channel 155 on the junction box 102, or a tool to access the screw 150 depending on the relevant stage of installation. The location and relatively large size of the access opening168 can provide improved access for different sizes of fasteners or corresponding hand tools for easy depth adjustment of the box 102 For example, an adjustment arm 170 (e.g., hooked, as shown) extends from the side wall 154, as shown in FIGS. 3A and 3B. As shown in FIG. 2, the adjustment arm 170 can capture the screw 150 to allow for rotational of the screw 150, but not axial movement. Thus, for example, with the screw 150 threadedly engaged with the threaded structure 148, the screw 150 can be accessed via the opening 168 to adjust a depth of the junction box 102 relative to the bracket 104. Notably, during the manufacturing process, the opening 168 allows the forming of the adjustment arm 170 (e.g., with a stamping die). The opening 168 further provides a clearance that allows the screw 150 to be installed on the adjustment arm 170, as noted above. As similarly discussed above, the inward projection of the channel 146 allows both the screw 150 and the adjustment arm 170 to be received within the outer envelope of the box 102. This alignment of the screw 150, in particular, allows the junction box 102 to be easily adjusted after installation without cutting additional holes in the drywall, as well as to be installed closely to the wall stud 106, in contrast to conventional designs (see, e.g., FIG. 11).

In different examples, different attachment structures can be provided on a mounting bracket to secure the mounting bracket to a stud. As illustrated in FIG. 3B, an upper hook 172 and a lower hook 174 extend from the front wall 164, opposite to the side wall 154 to collectively provide another side wall (e.g., an anchor wall). With reference to FIG. 11, the upper and lower hooks 172, 174 can be engaged with the wall stud 106 during installation by a levering movement of the mounting bracket 104 that pivots the mounting bracket 104 around a front wall 166 of the wall stud 106 to align the junction box 102 along a first side of the stud 106 and correspondingly urge the hooks 172, 174 into a second, opposite side of the wall stud 106.

In some examples, fasteners can be used to secure a mounting bracket to a stud. For example, with reference to FIGS. 1 and 11, a staple 176 can be installed to extend through an upper opening 178 and a lower opening 180 of the front wall 164 to further secure the mounting bracket 104 to the wall stud 106. Generally, the openings 178, 180 can be separated by a web 184 with a relatively thin width, selected to allow deformation of the web 184 by the staple 176. For example, as shown in FIG. 3B, the front wall 164 can have a middle opening 182 positioned between the upper opening 178 and the lower opening 180 to provide for thinner material at the web 184 and correspondingly increased deformation of the web 184 into the stud 106 (see FIG. 11) by the staple 176.

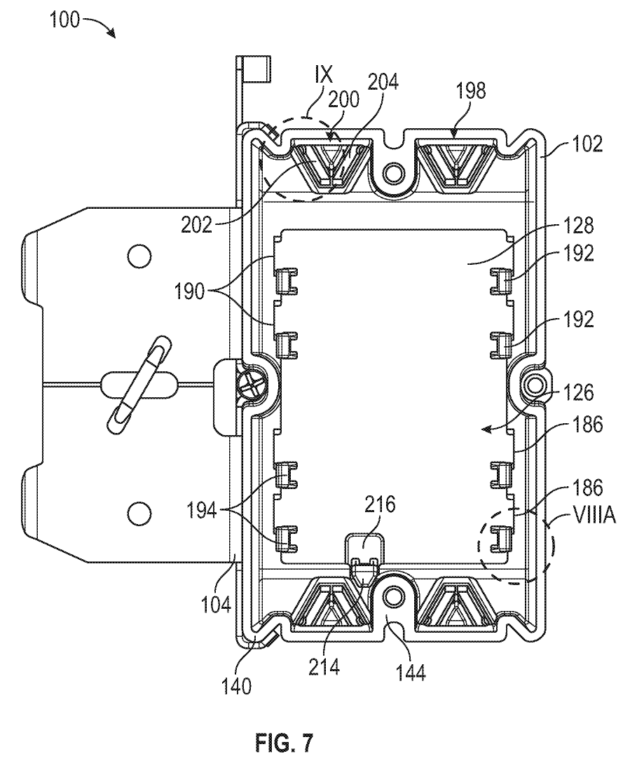

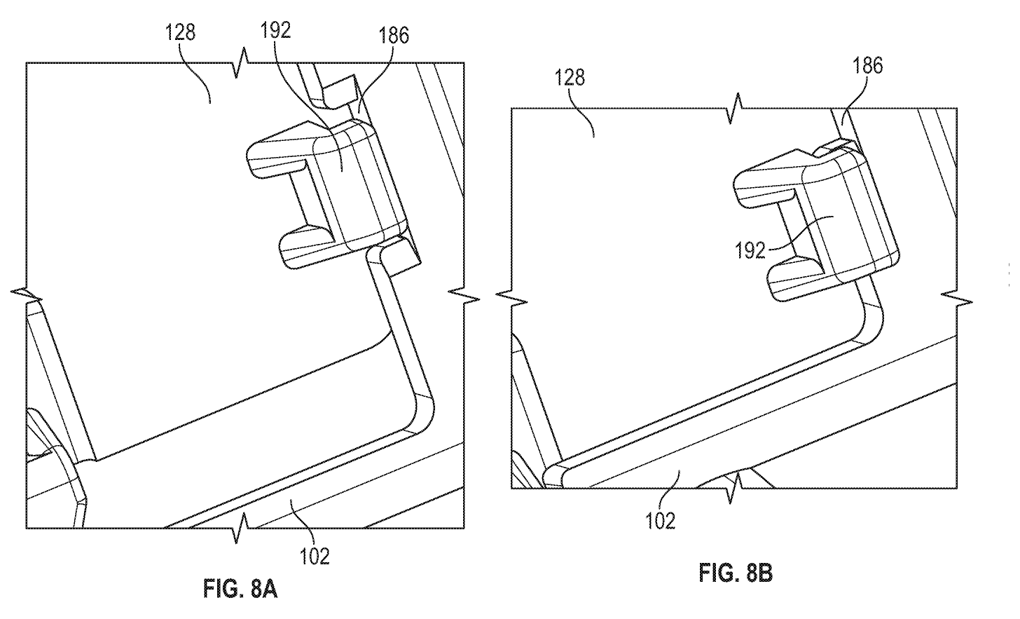

As noted above, it may be useful in some cases to provide a removable cover for the junction box 102. Referring back to FIG. 2, for example, the electrical assembly 100 is shown with the back cover 128 removed, which can allow an installer to access a back side of an electrical device (see, e.g., FIG. 10) after installation of the assembly 100 on a stud. In different examples, such a cover can be secured in different ways (e.g., a tab and slot mechanism). As shown in FIGS. 7 through 8B, the back wall 112 has slots 186, 190 that are arranged between the top portion 122 and the bottom portion 124 of the back wall 112, along opposite sides of the rear opening 126. The slots 186, 190 can receive corresponding tabs 192, 194 of the back cover 128, for sliding installation or uninstallation of the cover 128 on the box 102.

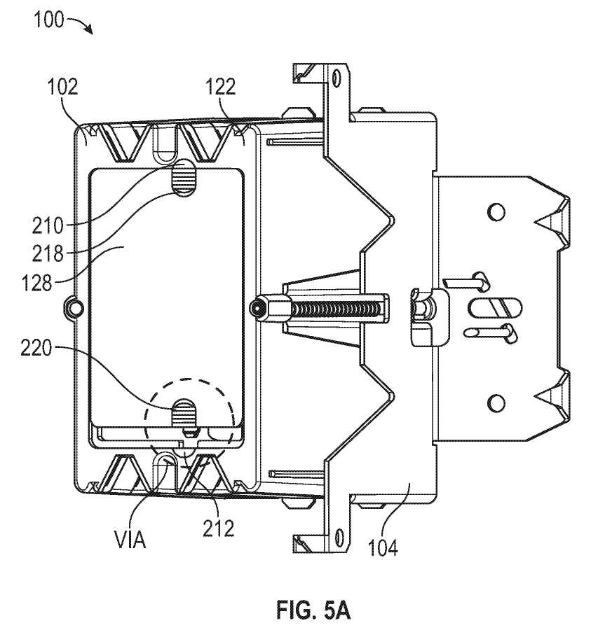

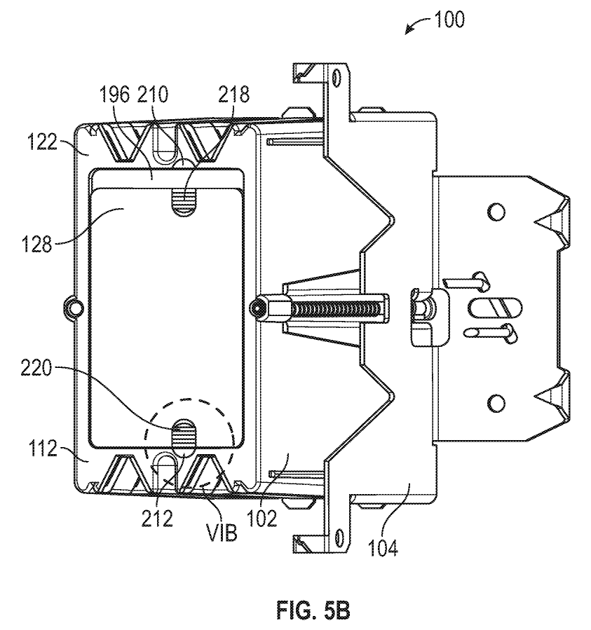

Further shown in FIG. 5B, an upper ledge 196 extends along the top side of the opening 126, beneath the top portion 122 of the back wall 112. The upper ledge 196 can be exposed when the back cover 128 is in a closed configuration to fully block access to the interior of the box 102 via the rear opening 126. With reference also to FIG. 5A, the cover can be slid upwards along the ledge 196 to a staged configuration for removal from the box 102, or can be thus aligned before being slid downward to the closed configuration of FIG. 5B.

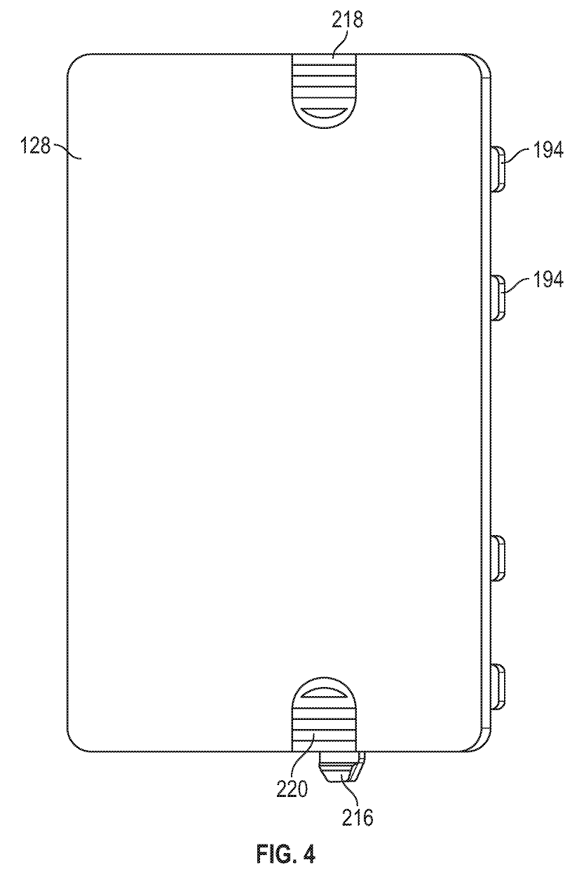

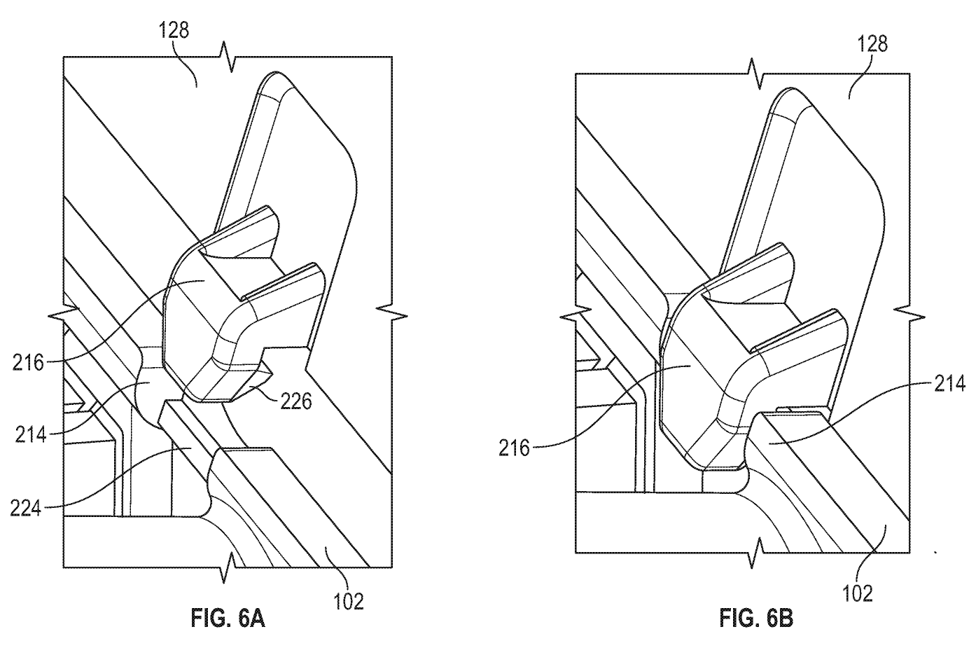

In some examples, features for improved user engagement can be provide. For example, as shown in FIG. 5A and 5B, the back wall 112 can further include an upper recess 210 and a lower recess 212 that can be aligned with recesses 218, 220 on the cover 128 (see also FIG. 4) for easier manual engagement to slide the cover 128. Referring also to FIGS. 6A and 6B, the lower recess 212 may be aligned with a lower slot 214 that receives a lower tab 216 on the back cover 128 to secure (e.g., latch) the back cover 128 to the junction box 102. Such an alignment of the lower recess 212 with the lower slot 214 helps align manual engagement with the back cover 128 to more easily disengage the lower tab 216 of the back cover 128 to release the back cover 128 from the junction box 102 by sliding.

FIGS. 6A and 6B further illustrate the lower slot 214 on the junction box 102 in the configuration of FIGS. 5A and 5B, respectively. In particular, the lower slot 214 has a ledge 224 that extends between the edges of the lower slot 214. Further shown, the lower tab 216 cantilevers outwardly from the back cover 128 and has a ridge 226 that extends back towards the back cover 128. The ridge 226 snap- engages the ledge 224 of the junction box 102 to position the back cover 128 in the closed configuration. As shown in FIG. 6B, the lower tab 216 of the back cover 128 extends into the lower slot 214. Advantageously, this tab and slot mechanism between the back cover 128 and the junction box 102 allows installation of the back cover 128 to the junction box 102 without the use of fasteners or other tools.

Thus, to secure the back cover 128 to the junction box 102, a user aligns the back cover 128 in the staged configuration (see, e.g., FIG. 5A), which aligns the upper notch 210 and the upper recess 218. The user then slides the cover downwardly to expose the upper ledge 196 and aligns the lower recess 212 and the lower recess 220, which positions the back cover 128 in the closed configuration (see, e.g., FIG. 5B). Correspondingly, to remove the back cover 128 from the junction box 102, a user can slide the back cover 128 upwardly to the staged configuration (see, e.g., FIG. 5A), then move the back cover 128 away from the junction box 102 to provide access to the holding area 120 via the rear opening 126.

In different examples, other access openings can be provided, including for entry of cables into the holding area 120 in an installed configuration. For example, as shown in FIG. 2, the top wall 108 includes a right upper cable entry 198 positioned between the upper support structure 136 and the right upper groove 130, and a left upper cable entry 200 positioned between the upper support structure136 and the left upper groove 132. In particular, the entries 198, 200 are both configured as a V-shaped entries for non-metallic insulated cables, with flaps 202, 204 (see FIG. 7) that can flex relative to adjacent structure of the box 102 to admit conductors into the holding area 120. Correspondingly, the bottom wall 110 also includes right lower and left lower cable entries 206, 208 that function and provide the same benefits as the upper right and left upper cable entries 198, 200.

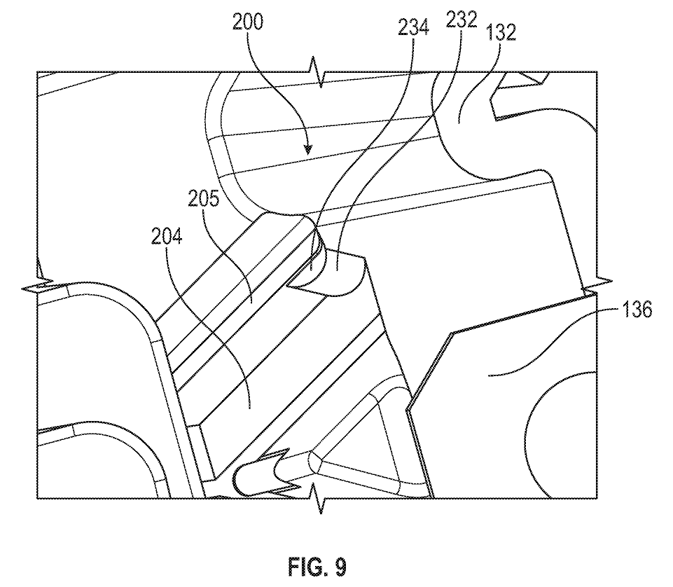

FIG. 9 shows an enlarged view of the upper left cable entry 200. In particular, an indentation 232 extends along a proximal end of the flap 204 to provide a locally thinned area material. The entrance flap 202 of the cable entrance 200 can thus preferably bend at the indentation 232 during installation of a cable (e.g., rather than fracture due to adverse concentration of forces in conventional designs). This benefit may be further accentuated by the position of the indentation 232 relative to the strengthening structure of the upper groove 132, which may further ensure that force from the cable deflects the flap 202 rather than breaking the box 102. Further, an end wall 234 of the indentation 232 can be provided, to ensure that a gap 205 between the base flap 204 and other structure of the box 102 maintains a sufficiently small width to comply with code requirements. Although shown for the flap 202 in particular, similar arrangements may be similarly applied to each cable entrance of the cable entries 198, 200, 206, 208.

FIG. 10 shows the electrical assembly 100 with an outlet 236 installed in the holding area 120 of the junction box 102, although other electrical devices are possible. In particular, the outlet 236 is installed to the junction box 102 by fastening an upper support 238 to the upper support structure 136 of the junction box 102 (e.g., with screws). Correspondingly, a lower support 240 may be fastened to the lower support structure144 of the junction box 102 (e.g., with screws). Other protruding portions of the upper support 238 and the lower support 240 may be further removed (e.g., shaved or filed off) to provide the junction box 102 with a relatively smooth, continuous outer profile to guide a routing tool for the cutting of drywall. In some implementations, the illustrated assembly (e.g., with further trimming of the supports 238, 240) may be advantageously completed during a manufacturing process, remotely from an installation site (e.g., so the electrical assembly 100 with the outlet 236 installed comes preassembled to an end installer).

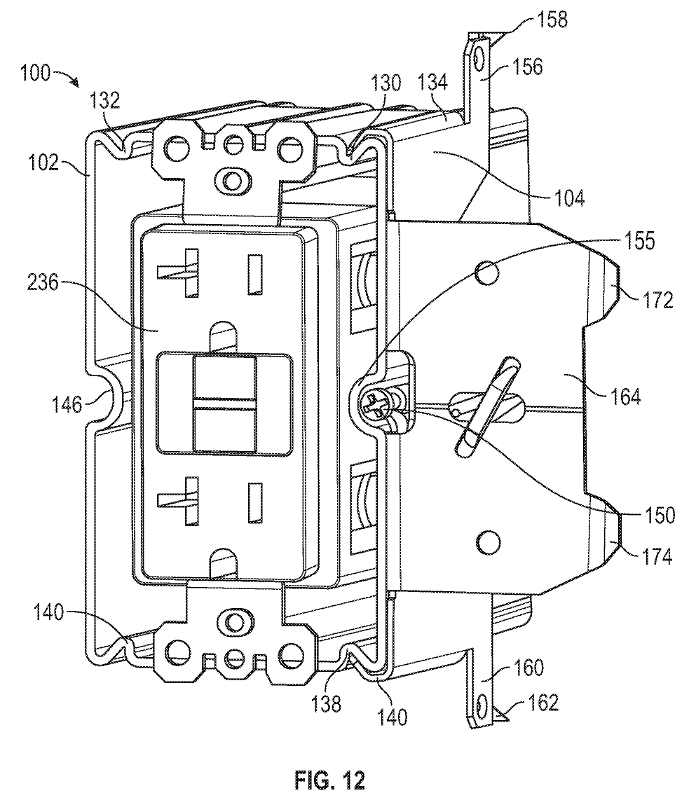

As mentioned above, FIG. 11 illustrates the electrical assembly 100 secured to the wall stud 106 and the outlet 236 secured within the junction box 102. In this configuration, the front wall 164 of the mounting bracket 104 seats against the front wall 166 of the wall stud 106. The screw 150 is shown installed in the left side channel 146 of the junction box 102 and accordingly extends along a right side wall 246 of the wall stud 106. Further, the mounting bracket 104 is wrapped around the front 166 and the side walls 246, 248 of the stud 106, with the upper and lower hooks 172, 174, engaging the left side wall 248 of the stud 106 (i.e., on the opposite side from the right side wall 246). In an alternative configurations, as shown in FIG. 12, the bracket 104 may be aligned to support the junction box 102 on the left side wall 248 of the stud 106 (e.g., without having to rotate the box 102, as would require removal and reattachment of the outlet 236 to avoid inversion thereof).

In the example shown, the staple 176 is secured into the front wall 166 of the wall stud 106 to further secure the mounting bracket 104. As discussed above, in some cases, the staple 176 can deform the mounting bracket 104 inward into the front wall 166 of the wall stud 106 at the webs 184 between the top, middle, and lower openings 178, 182, 180 of the mounting bracket 104. Further the upper barb 158 and the lower barb 162 of the mounting bracket 104 have been hammered into penetrating engagement with the right side wall 246 to further secure the electrical assembly 100 the wall stud 106.

Thus installed, and as also discussed above, a depth of the junction box 102 is adjustable relative to the wall stud 106. In particular, by rotating the screw 150, a user can cause the arms 134, 142 to slide along the corresponding grooves 132, 140 (or 138, 140) of the junction box 102 to adjust a depth of the box 102 relative to the bracket 104 and thereby the stud 106. Correspondingly, the grooves 130, 132, 138, 140 allow for the electrical assembly 100 to be installed at any depth on the wall stud 106, on either side of the stud 106, while also improving the strength of the electrical assembly 100 overall. Further, as needed, a user can remove the rear cover 128 to make appropriate electrical connections within the (installed) assembly 100.

In an installation example, an installer can thus install a prefabricated assembly as shown in FIG. 10 (or otherwise configured) and, after securing the assembly to a stud, access the interior of the assembly via the rear opening to connect an electrical device. Further, the assembly can be intentionally positioned so that the junction box 102 protrudes forward from the front wall 166 of the wall stud 106, to guide installation of drywall over the assembly to install drywall or other wall coverings (e.g., to guide a proper cut of an opening in drywall for the junction box 102 to extend through). In some examples, the junction box 102 may be further adjusted after the drywall installation to properly align the box 102 relative to an outer surface of the drywall or other reference point (e.g., to install a cover plate around the outlet 236 of the junction box 102, flush with the room-side drywall surface).

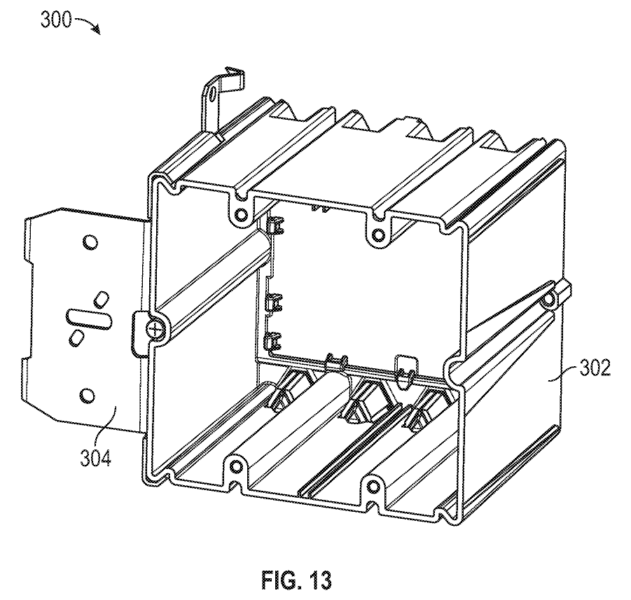

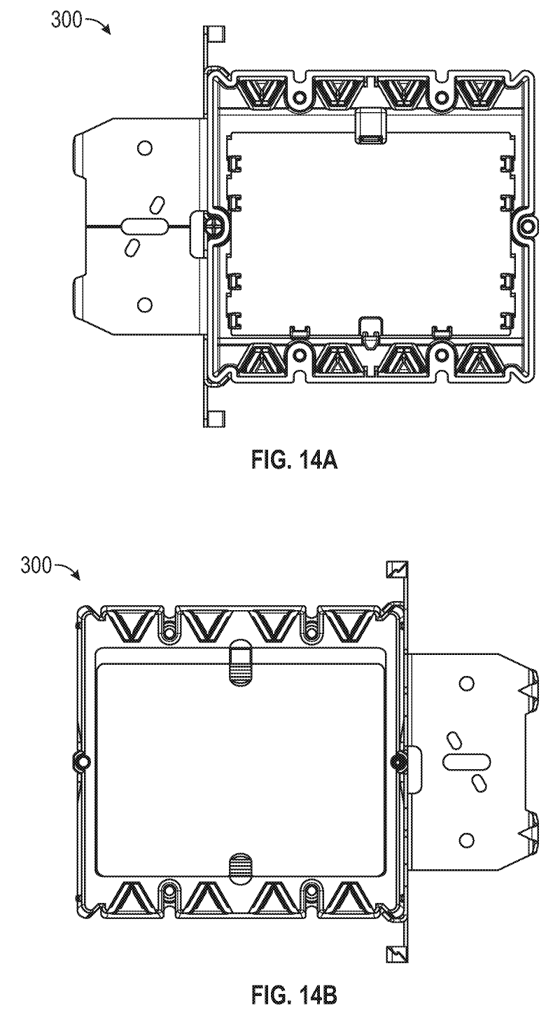

In different examples, similar principles can be implemented for differently sized or otherwise differently configured junction boxes. FIGS. 13 through 14B illustrate another example of a mounting assembly 300 according to another embodiment of the invention. In particular, the mounting assembly 300 has the similar features and function as the mounting assembly 300 discussed with respect to FIGS. 1 through 12, but is sized to support a multi-gang outlet assembly (e.g., with two two-outlet devices). Accordingly, junction box 302 instead has two upper apertures and two lower apertures that receive and secure electrical device(s) within and to the junction box 302. Correspondingly, the junction box 302 also has multiple cable entries.

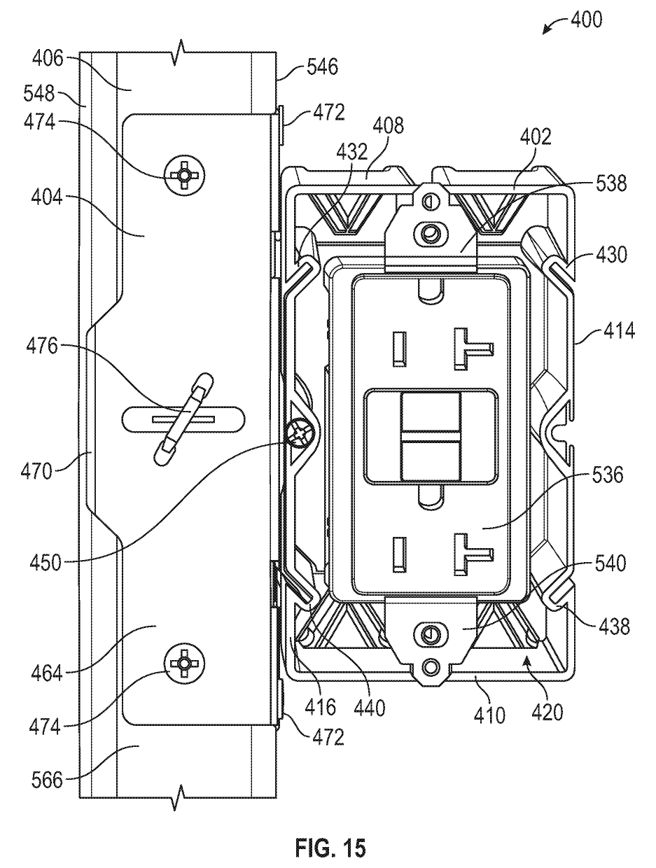

Turning now to FIG. 15, another example electrical assembly 400 according to another embodiment of the present disclosure is shown. In this embodiment, the assembly 400 has the same structure features as the assembly 100 and will be referenced with reference numerals increased by 300 as were similarly discussed above in connection with assembly 100, unless otherwise stated. For example, the electrical assembly 400 can be installed onto a right or left side wall of a wall stud, without having to remove or change the orientation of the electrical device.

For example, the assembly 400 has a junction box 402, a mounting bracket 404, and a wall stud 406 the assembly 400 is secured to. The junction box 402 has a top wall 408, a bottom wall 410, a back wall 412, a right side wall 414, a left side wall 416, which defines a holding area 420 and a rear opening 426. A back cover 428 is removably coupled to the junction box 402. An upper and lower support structures 436, 444, as well as a left side channel 446 and a right side channel 455 protrude into the holding area 420. A screw 450 allows for depth adjustment of the box 402 along arrow 405. The stud 406 has a front wall 566, a right side wall 546, and a left side wall 548. A staple can be installed through an upper opening 478 and a lower opening 480 and onto the stud 406. The upper and lower openings 478, 480 are separated by a web 484. Furthermore, an electrical device 536 is installed within the holding area 420 and is secured by fastening an upper support structure 538 to the upper support structure 436 and a lower support 540 fastened to the lower support structure 444 of the junction box 402 (e.g., with screws).

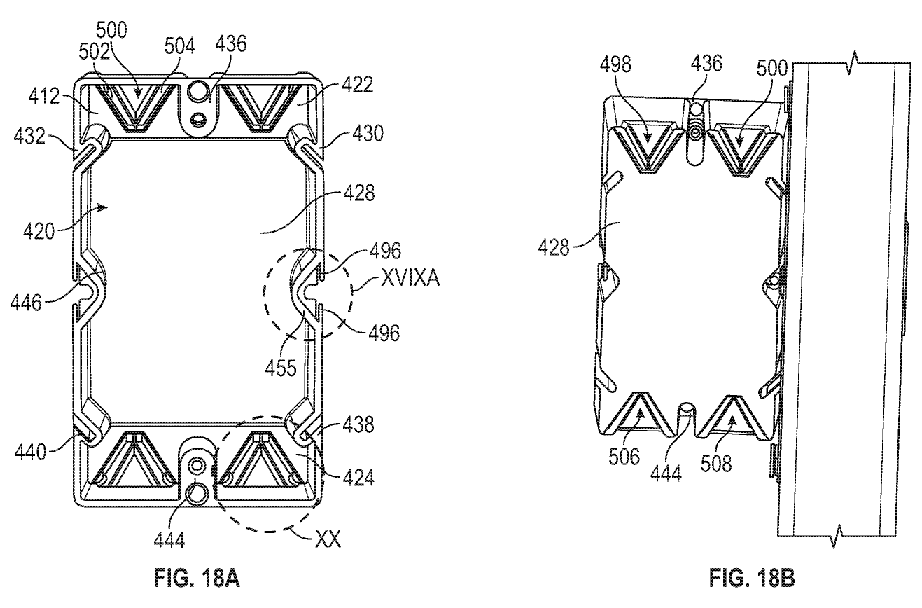

In this embodiment, grooves 430, 438 are disposed along the right side wall 414 and grooves 432, 440 are disposed along the left side wall 416. As illustrated, the grooves 430, 432, 438, 440 are angled and recessed into the holding area 420. In particular, the grooves 430, 438 are disposed on opposing sides of the left side channel 455 on the left side wall 416 and between the top wall 408 and the bottom wall 410 (e.g., see FIG. 18A). Correspondingly, the grooves 432, 440 are disposed on opposing sides of the right side channel 446 on the right side wall 414 and between the top wall 408 and bottom wall 410 (e.g., see FIG. 18A). This configuration creates a symmetrical arrangement that allows the mounting bracket 404 to be installed on either side of the junction box 402 without requiring modification or rotation of the electrical device 536, as will be further detailed below. This configuration also allows for larger cable openings at the ends of the junction box 402, which enhances overall usability by providing more space for cable routing and reducing installation complexity. Furthermore, the grooves 430, 432, 438, 440 are positioned away from the ends of the junction box 402 to provide maximum space for cable entries while maintaining sufficient separation to prevent interference with installed electrical devices (e.g., device 536). This configuration allows electrical devices 536 to be fully seated within the junction box 402 without obstruction from the groove structures.

Continuing, to provide enhanced mounting security and improved load distribution across the wall stud 406, fasteners 474 are secured through the bracket 404 and onto the front wall 566 of the wall stud 406 above and below the staple 476. Similarly, fasteners 472 are secured through the bracket 404 and onto the right side wall 546 of the wall stud 406. This multi-point attachment system, with fasteners 472 and 474 engaging the front 566 and right side wall 546 of the wall stud 406 and the staple 476 engaging the front wall 566, distributes mechanical loads effectively across multiple surfaces of the wall stud 406 and provides redundant securement that exceeds conventional single-point attachment methods. Furthermore, the fasteners 472, 474 provide a removable connection that allows the mounting bracket 404 to be unfastened and repositioned relative to the junction box 402, allowing the user to secure the junction box 402 to either the left or right side of the wall stud 406 without requiring modification or rotation of the electrical device 236. This reversible mounting capability enhances installation flexibility and accommodates varying jobsite conditions while maintaining the electrical device 236 in the same orientation.

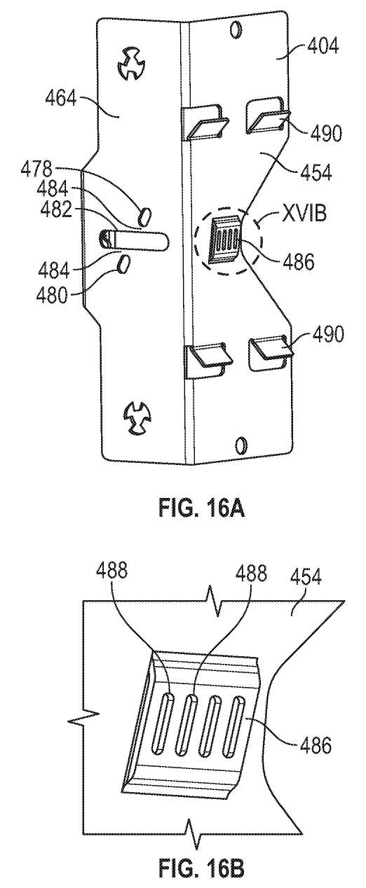

With specific reference to FIGS. 16A and 16B, the mounting bracket 404 is shown. As illustrated, a side wall (or adjustment wall) 454 of the mounting bracket 404 includes tabs 490 that extend outwardly in a cantilevered configuration from the side wall 454 (e.g., with two obliquely angled upper tabs and two obliquely angled lower tabs, as shown). These tabs 490 are positioned and sized to be received within the corresponding grooves 430, 432, 438, 440 of the junction box 402 when the mounting bracket 404 is in the installed position, to slidingly engage the junction box 402 and thus guide relative sliding movement between the junction box 402 and the mounting bracket 404. Accordingly, the tabs 490 are flexible to permit smooth sliding engagement during installation and depth adjustment operations, while simultaneously maintaining secure retention within the grooves 430, 432, 438, 440 to prevent inadvertent disengagement during use. This four-tab configuration provides balanced load distribution and secure attachment, though alternative embodiments may employ different numbers of tabs, such as two, three, five, six, or more tabs, depending on the specific application requirements and load considerations.

Between the tabs 490, a threaded structure 486 is positioned centrally on the side wall 454 and engages the screw 450 during depth adjustment operations. The threaded structure 486 is integrally formed with the side wall 454 (i.e., as cut-outs of the material of the side wall 454), although other configurations are possible, including separate threaded inserts or differently formed integral threaded features (e.g., stamped thread contours). The threaded structure 486 defines slots 488 that are configured to receive and engage the threads of the screw 450, creating a quick-adjustment mechanism.

In a particular example, the screw 450 features a relatively large diameter and relatively coarse thread pitch that allows the screw threads to engage directly with the slots 488 during rotation. The coarse thread configuration provides positive mechanical engagement while allowing for rapid depth adjustment with minimal rotational input. Further, as well as readily accommodating coarser thread, larger diameter screws, the slot-and-thread design (e.g., using the threaded structure 486) can eliminate the need for precise rotational alignment during initial engagement and significantly reduce installation time compared to conventional threaded fasteners. Further, the permitted use of relatively large diameter screws, with relatively coarse pitches, can simplify the processes of reconfiguring the box from left to right mounting by reducing (e.g., eliminating) the possibility of cross threading the screw – as may readily occur for conventional designs.

In the illustrated example, a single full turn of the screw 450 can translate to a 0.100 inch linear displacement of the junction box 402 relative to the mounting bracket 404, providing controlled depth adjustment for accurate alignment with drywall surfaces of varying thickness. Alternative embodiments may provide different adjustment ratios, such as about 0.050 inches, about 0.150 inches, or about 0.200 inches per full turn, depending on the specific thread pitch and slot geometry. In this way, the threaded structure 486 and slots 488 are designed with optimized surface geometry to minimize friction between the screw threads and slot walls, thereby allowing smooth, low-torque adjustments that can be performed efficiently with standard screwdrivers or drill bits without requiring excessive force or specialized tools.

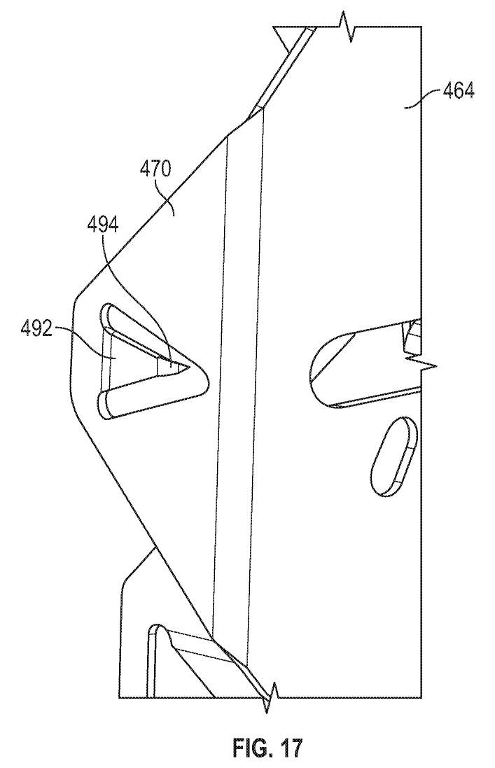

Turning now to FIG. 17, a side wall (or anchor wall) 470 extends perpendicularly from the front wall 464 of the bracket 404, opposite the side wall 454. The side wall 470 includes an anchor tab 492 that projects from the side wall 470, with a barb 494 formed at the distal end of the anchor tab 492. In this example, the barb 494 creates a mechanical retention system that securely engages the wall stud 406 through directional resistance. In particular, during installation, the angled geometry of the barb 494 permits the bracket 404 to slide smoothly onto the wall stud 406 with minimal insertion force, as the barb 494 deflects against the stud surface. Once fully seated, the barb 494 penetrates into the stud 406 and the angular configuration creates a mechanical interference that resists withdrawal forces, preventing accidental removal during use or subsequent adjustment operations. The linear engagement mechanism allows the installer to push the bracket 404 and junction box 402 directly onto the stud 406 in a single axial motion without requiring rotational positioning or angular alignment. This streamlined installation approach reduces assembly complexity and minimizes the potential for installation errors.

FIGS. 18A and 18B illustrate the junction box 402. As shown, the back cover 428 has the same contour along the grooves 430, 432, 438, 440 so that the cover 428 has an interference fit and can be removed and installed as needed to provide access to the holding area 420 via a rear opening 426 when the electrical device 536 is installed. The interference fit allows secure closure of the cover 428 while allowing tool-free removal when access is required. Further shown, the junction box 402 includes a right upper cable entry 498 positioned between the upper support structure 436 and the right side wall 414, and a left upper cable entry 500 positioned between the upper support structure 436 and the left side wall 416. Cable entries 498, 500 have flaps 502, 504 that can flex relative to adjacent structure of the junction box 402 to admit conductors into the holding area 420. The flaps 502, 504 are configured to provide secure cable retention while allowing easy insertion during installation. Correspondingly, there are right lower and left lower cable entries 506, 508 that function and provide the same benefits as upper right and upper left cable entries 498, 500. In this example, the right side channel 455 and the left side channel 446 each have two arms 496 that align and secure the screw 450 when installed, providing positive retention and preventing accidental displacement during adjustment operations.

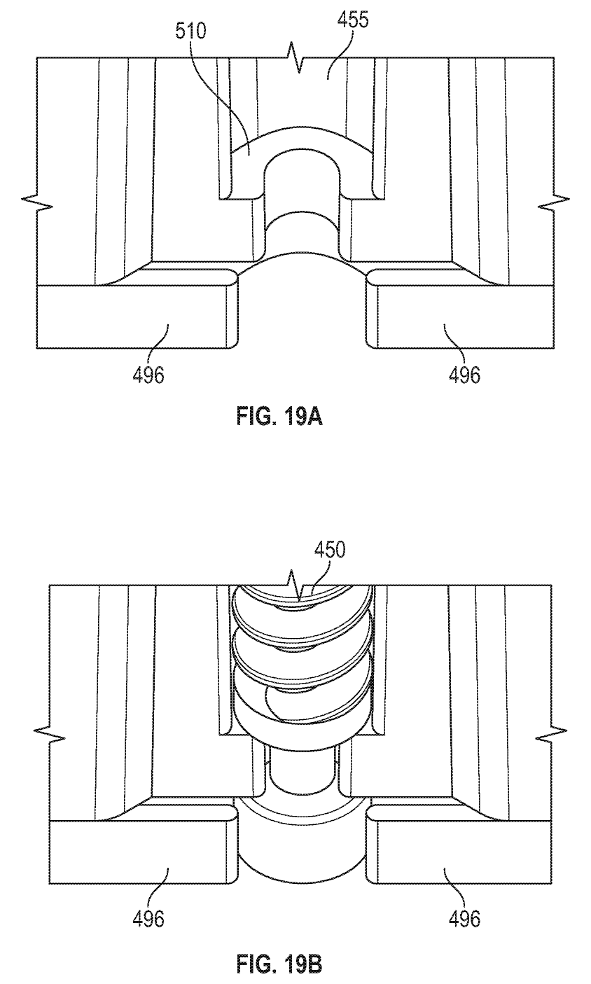

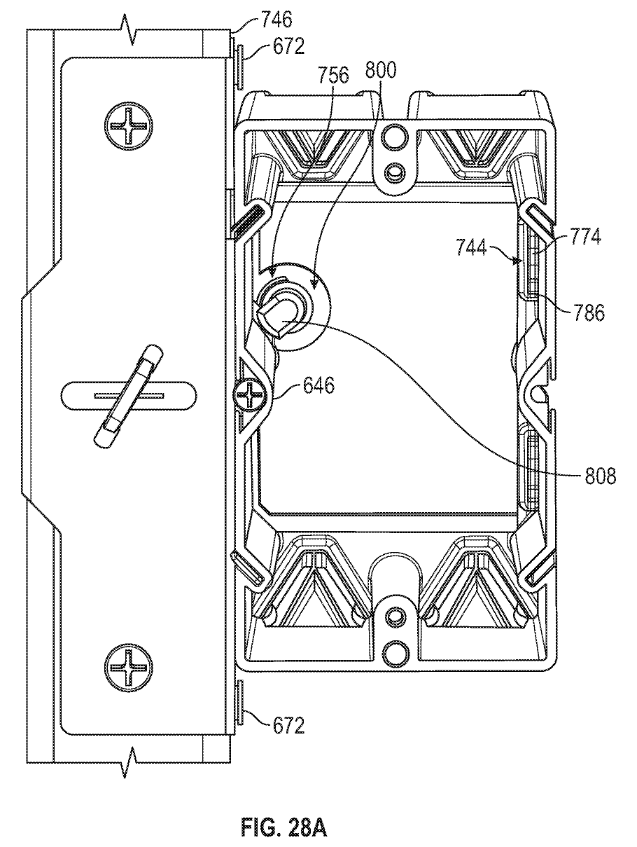

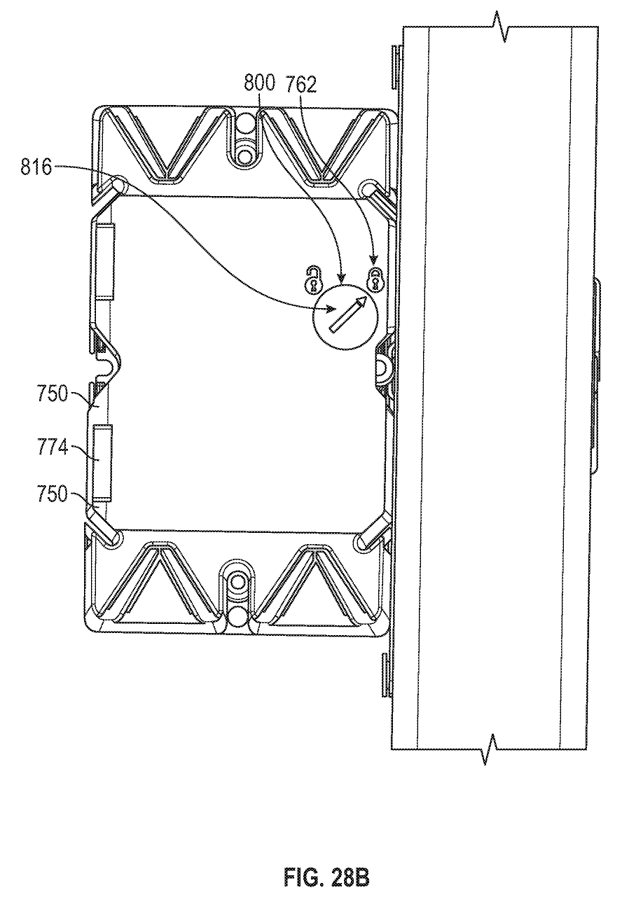

For example, turning now to FIGS. 19A and 19B , the right side channel 455 is shown. As illustrated in FIG. 19A, a retention structure 510 is positioned within the right side channel 455 opposite the arms 496 to provide a backing surface to help with screw retention and to guide rotation of the screw 450 during depth adjustments. In this example, the arms 496 made of a resilient material to deflect inwardly when the screw 450 is initially inserted, allowing the enlarged head of the screw 450 to pass through the arms 496 during installation. Once the screw head clears the arms 496, the arms 496 resiliently return to their original position, creating a retention interface that lightly captures the screw 450 within the channel 455 (e.g., with a snap-engagement relative to the screw head)). In this way, the screw 450 can be positioned between the opposing arms 496 and the retention structure 510, which together create a secure but adjustable connection that maintains the screw 450 in proper alignment within the channel 455. This retention system prevents accidental removal of the screw 450 during normal operation while still allowing rotational movement for depth adjustment of the junction box 402, and permits intentional removal when necessary for maintenance or reconfiguration of the assembly. Indeed, in some cases, an opposite end of the screw may correspondingly float freely within the right side channel 455 (see also FIG. 28B), as may help to provide simplified construction and easier operation overall. Correspondingly, the left cable channel 446 also includes the arms 496 and retention structure 510 which function and provide the same benefits as the right side channel 455.

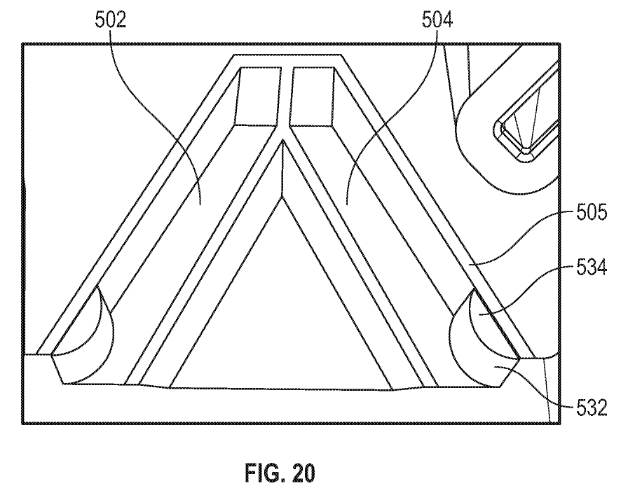

Referring now to FIG. 20, the flaps 502 and 504 are shown. As shown, an indentation 532 extends along a proximal end of the flap 504 to provide a locally thinned area of material. The entrance flap 504 can thus preferentially bend at the indentation 532 during installation of a cable, preventing stress concentration that could lead to cracking or failure. An end wall 534 of the indentation 532 is provided to ensure that a gap 505 between the flap 504 and other structure of the junction box 402 maintains a sufficiently small width to comply with electrical code requirements while allowing proper cable insertion and retention.

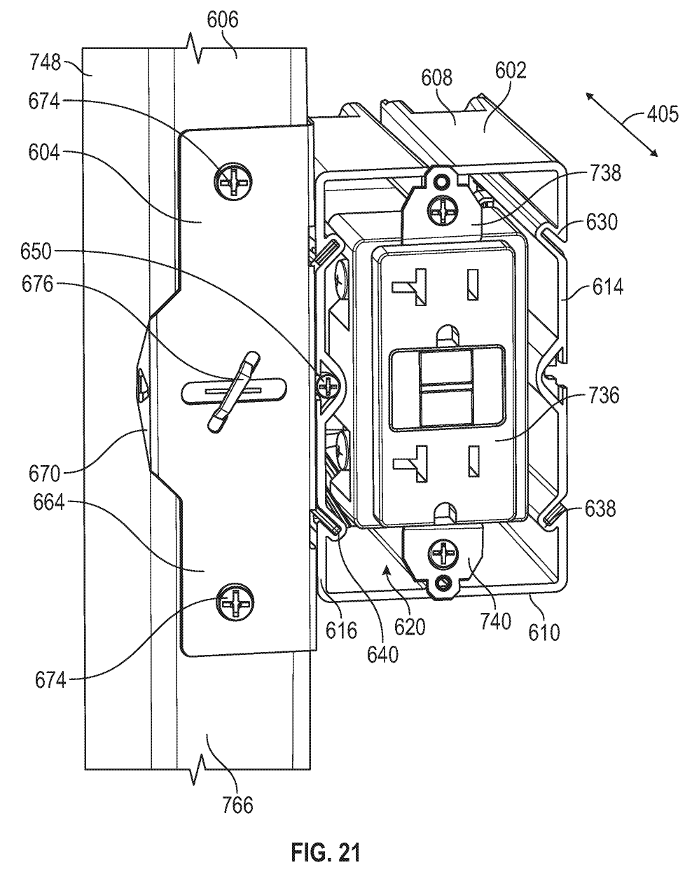

Turning now to FIG. 21, another example electrical assembly 600 according to another embodiment of the present disclosure is shown. In this embodiment, the assembly 600 has the same structural features as the assembly 400 and will be referenced with reference numerals increased by 200 as were similarly discussed above in connection with assembly 400, unless otherwise stated.

For example, the assembly 400 has a junction box 602, a mounting bracket 604, and a wall stud 606 the assembly 600 is secured to. The junction box 602 has a top wall 608, a bottom wall 610, a back wall 612, a right side wall 614, a left side wall 616, which defines a holding area 620 and a rear opening 626. A back cover 628 is removably coupled to the junction box 602. An upper and lower support structures 636, 644, as well as a left side channel 646 and a right side channel 655 protrude into the holding area 620. A screw 650 allows for depth adjustment of the box 602. The stud 606 has a front wall 766, a right side wall 746, and a left side wall 748. A staple can be installed through an upper opening 678 and a lower opening 680 and onto the stud 606. The upper and lower openings 678, 680 are separated by a web 684. Furthermore, an electrical device 736 is installed within the holding area 620 and is secured by fastening an upper support structure 738 to the upper support structure 636 and a lower support 740 fastened to the lower support structure 644 of the junction box 602 (e.g., with screws).

Furthermore, cable entries 698, 700 have flaps 702, 704 that can flex relative to adjacent structure of the junction box 602 to admit conductors into the holding area 620. The flaps 702, 704 are configured to provide secure cable retention while allowing easy insertion during installation. Correspondingly, there are right lower and left lower cable entries 506, 508 that function and provide the same benefits as upper right and upper left cable entries 498, 500. An indentation 532 extends along a proximal end of the flap 704 to provide a locally thinned area of material. An end wall 534 of the indentation 532 is provided to ensure that a gap 705 between the flap 704 and other structure of the junction box 602 maintains a sufficiently small width to comply with electrical code requirements while allowing proper cable insertion and retention.

The right side channel 655 and the left side channel 646 each have two arms 696 and a retention structure 710 that align and secure the screw 650 when installed, providing positive retention and preventing accidental displacement during adjustment operations.

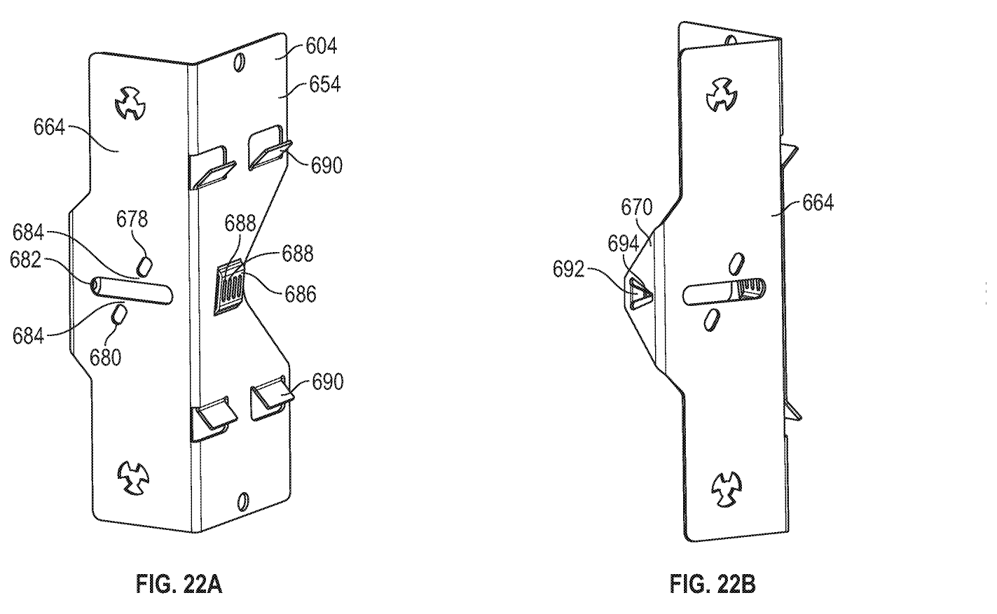

Correspondingly, as shown in FIGS. 22A and 22B, the mounting bracket 604 includes a front wall 664, side wall 654, an adjustment wall 670, four tabs 690 extending from the side wall 654, a threaded structure 686 defining slots 688. A hook 692 extending from the adjustment wall 670 and a barb 694. In some examples, the mounting bracket 604 can be the same as or similar to the mounting bracket 404 (see, e.g., FIG. 16A) and discussion above of the mounting bracket 404 also applies to the mounting bracket 604 unless otherwise indicated.

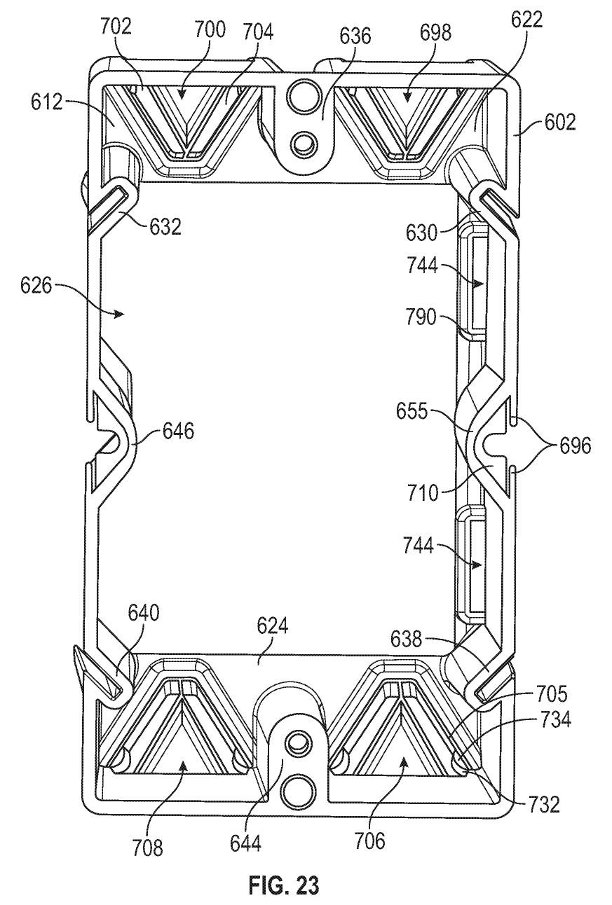

Turning now to FIG. 23, the junction box 602 is shown. In this example, the junction box 602 has pockets 744 positioned between the upper groove 630 and the right side channel 655, and between the right side channel 655 and the lower groove 638. The pockets 744 have open bottoms and provide secure engagement points for the hinged back cover 628, as will be further detailed below. The pockets 744 in this example are shown positioned along the right side wall 614 but can also be provided along the left side wall 616 in other configurations. This configuration also allows the junction box 602 to be produced using conventional open and closed tooling methods that significantly reduce manufacturing cost and complexity. The simplified geometry further eliminates the need for specialized molding equipment or complex multi-part tooling assemblies, allowing for efficient high-volume production while maintaining structural integrity and dimensional accuracy of the finished components.

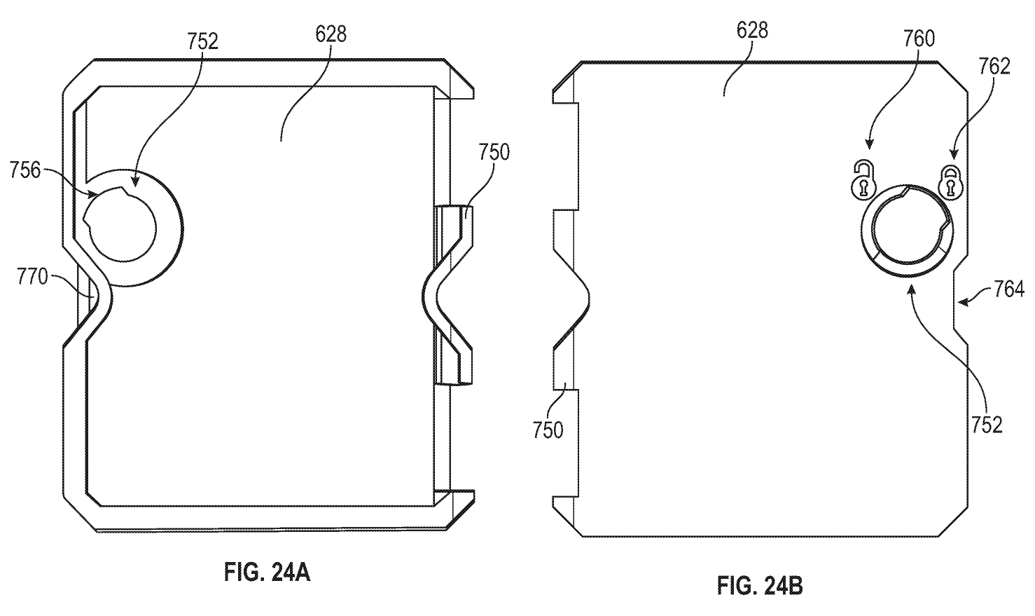

With reference now to FIGS. 24A and 24B, the back cover 628 is shown which is aligned with the corresponding pockets 744 when in an installed position relative to the box 602. In particular, the back cover 628 has knuckles 750 that facilitate hinged movement of the cover 628 relative to the junction box 602, allowing the cover 628 to swing open for access to the holding area 620 while remaining attached to the junction box 602. In this way, the back cover 628 hingedly moves about the knuckles 750, although other configurations such as sliding mechanisms or removable covers are possible in alternative embodiments.

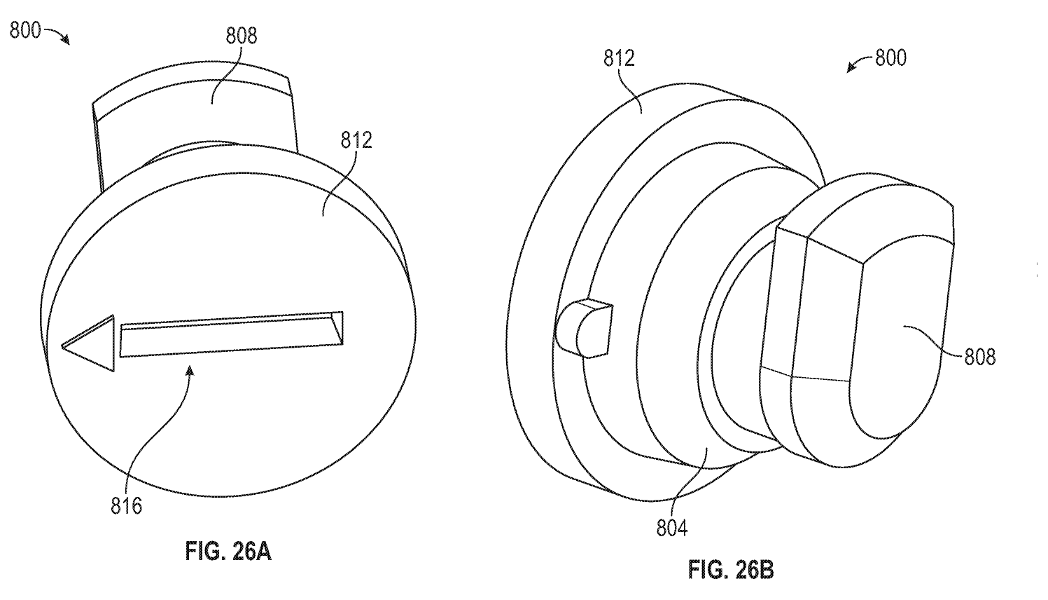

The back cover 628 includes an opening 752 that provides a locking mechanism to secure the cover 628 relative to the junction box 602. The opening 752 defines a clearance portion 756 having an enlarged diameter relative to other portions of the opening 752. This enlarged clearance portion 756 is configured to receive and accommodate rotational movement of a key's engagement piece (e.g., engagement piece 808, see FIGS. 26A, 26B) during locking and unlocking operations. When the engagement piece 808 is aligned with the clearance portion 756, the key (e.g., key 800, see FIGS. 26A, 26B) can be rotated to unlock the back cover 628, allowing the cover 628 to be opened for access to the holding area 620 of the junction box 602. Conversely, when the engagement piece 808 is rotated to a position where it is misaligned with the clearance portion 756, the key 800 prevents removal of the back cover 628, thereby maintaining the cover 628 in a locked configuration. This quarter-turn locking mechanism provides secure closure while allowing tool-free access when unlocked.

As shown on the back cover 628 in FIG. 24B, the cover 628 has visual indicators indicating to a user an unlocked position 760 and locked position 762, although other indications such as tactile indicators are possible in alternative embodiments. Adjacent the opening 752, a cutout 764 contours the right side channel 655 to allow the back cover 628 to be in the closed position and prevents contaminants from entering the junction box 602 when in the locked position. Furthermore, the cutout 764 has a grip 770 a user can manipulate to facilitate movement of the back cover 628 between the unlocked and locked position.

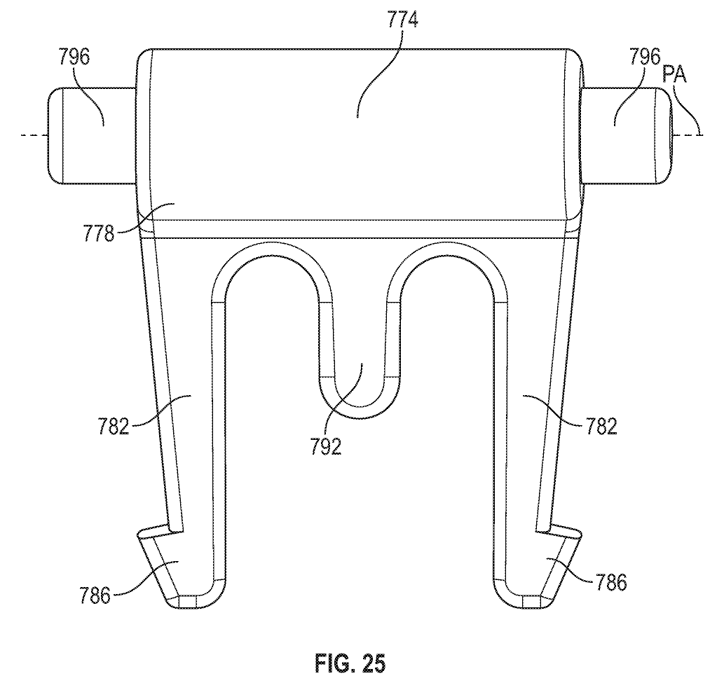

In some examples, insertable hinge clips can be included, to simplify manufacturing and construction or to provide sacrificial components for improved product performance. For example, turning now to FIG. 25, a clip 774 is shown that provides the mechanical rotating (e.g., pinned) connection between the back cover 628 and the junction box 602. Generally, the clip 774 can be snap-engaged with the junction box 602 to provide mounting points for rotatable attachment of the back cover 628. In the illustrated example, the clip 774 has a body 778 defining arms 782 that extend from the body 778 to provide structural support and engagement surfaces of the clip 774. Flanges 786 extend from the arms 782 and are configured to secure the clip 774 in the installed position by engaging with corresponding features on the junction box 602, as will be further described below. Hinge pins 796 extend from the clip 774, to be inserted within the knuckles 750, and thereby provide a pivot axis PA for hinged movement of the back cover 628. In particular, the hinge pins 796 are resiliently received within the knuckles 750, allowing for easy assembly while providing secure retention during operation.

The clip 774 further has a tab 792 disposed between the arms 782 and is shorter than the arms 782, providing additional structural support and alignment guidance during installation. In particular, because the tab 792 extends from the body 778 at a reduced length compared to the arms 782, the arms 782 can engage with the junction box 602 while the tab 792 provides intermediate positioning and prevents lateral movement of the clip 774 during assembly operations.

Turning now to FIGS. 26A and 26B, the key 800 that is received within the opening 752 is shown. In this example, the key 800 has a body 804. Extending from the body 804 is an engagement piece 808 that is received within the opening 752 and provides the mechanical interface for locking and unlocking operations. Opposite the engagement piece 808 is an actuator 812 that allows a user to rotate the key 800 between the locked and unlocked positions with controlled rotational movement in a quarter-turn increment, although other increments are possible. The actuator 812 has an indicator 816 that indicates to a user the current status of the key 800, providing clear visual feedback regarding the locked or unlocked state of the cover 628.

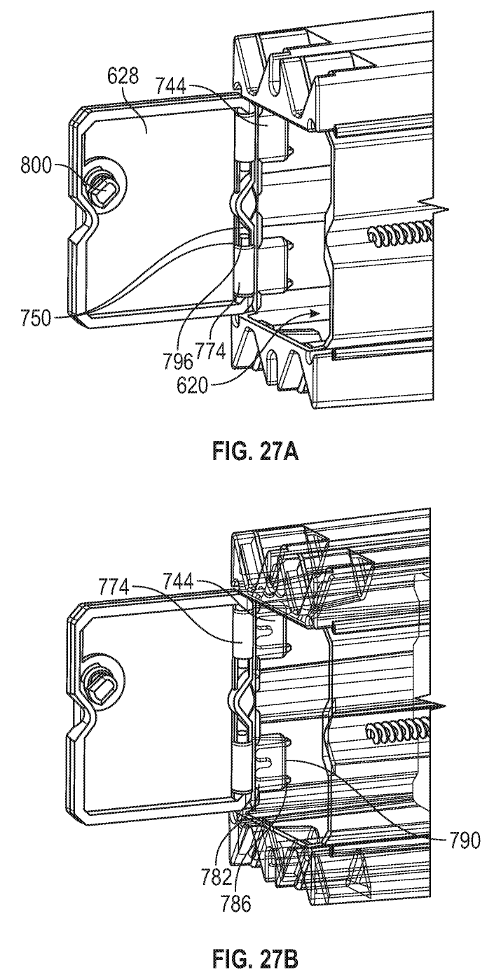

Referring now to FIGS. 27A and 27B, the back cover 628 is shown installed within the pockets 744 and positioned in the open configuration, with the key 800 spaced away from the junction box 602 to provide access to the holding area 620. In this position, the hinge pins 796 are securely retained within the knuckles 750, maintaining a permanent connection between the cover 628 and the junction box 602 unless the hinge pins 796 are intentionally disengaged or subjected to excessive force. In this way, the hinge pins 796 are configured as low-cost, field-replaceable sacrificial components that protect the structural integrity of both the junction box 602 and the back cover 628 during normal use and potential misuse. When excessive force is applied to the cover 628—whether during installation procedures, electrical inspections, accidental impact, or deliberate misuse—the hinge pins 796 are engineered to fail preferentially before mechanical stress can propagate to and damage the junction box 602 or back cover 628 components. This controlled failure mechanism prevents costly structural damage such as cracking, deformation, or material fracture of the primary components, which would otherwise necessitate complete replacement of the junction box 602 and potentially require extensive rework of installed electrical wiring connections. The field-replaceable nature of the hinge pins 796 allows for rapid, inexpensive repair that maintains full electrical code compliance of the junction box 602 without compromising the integrity of the overall electrical installation. By strategically isolating mechanical stress to these disposable components, the hinge pins 796 significantly reduces service time, minimizes material waste, and eliminates the risk of electrical system disruption that would result from junction box replacement.

Furthermore, in this position, the flanges 786 extend through the pockets 744 and are hooked over an undercut 790 of the pockets 744 to create a secure mechanical connection. More specifically, during installation, when the arms 782 are initially inserted into the pockets 744, the arms 782 deflect inwardly due to their resilient material properties, allowing the flanges 786 to clear the entry opening within each pocket 744. Once the flanges 786 are fully inserted past the entry opening, the arms 782 elastically return to their original outward position, causing the flanges 786 to snap outwardly and engage with the undercut 790 formed within each pocket 744. This snap-fit engagement creates a positive mechanical lock that securely retains the clip 774 and the attached cover 628 relative to the junction box 602. This retention mechanism prevents accidental misplacement or loss of the cover 628 during shipping, installation procedures, or electrical inspections, while simultaneously maintaining the structural integrity of the junction box 602. The secure but removable connection further allows authorized personnel to easily access the holding area 620 for electrical code enforcement inspections or maintenance of installed wiring without requiring complete disassembly of the electrical assembly or compromising the junction box 602 structural integrity.

Referring now to FIGS. 28A and 28B, the back cover 628 is shown in the locked position. In particular, as shown in FIG. 28A, the engagement piece 808 engages with internal structure of the junction box 602 (e.g., an internal feature at an end of the internal wall of the left side channel 646), which maintains the back cover 628 in the locked position. In this locked configuration, the engagement piece 808 cannot pass through the opening 752 due to the dimensional interference, securing the back cover 628 in place relative to the box 602. Correspondingly, the indicator 816 on the key 800 points to the locked position indicator 762 on the back cover 628, providing visual confirmation to a user that the back cover 628 is secured in the locked position.

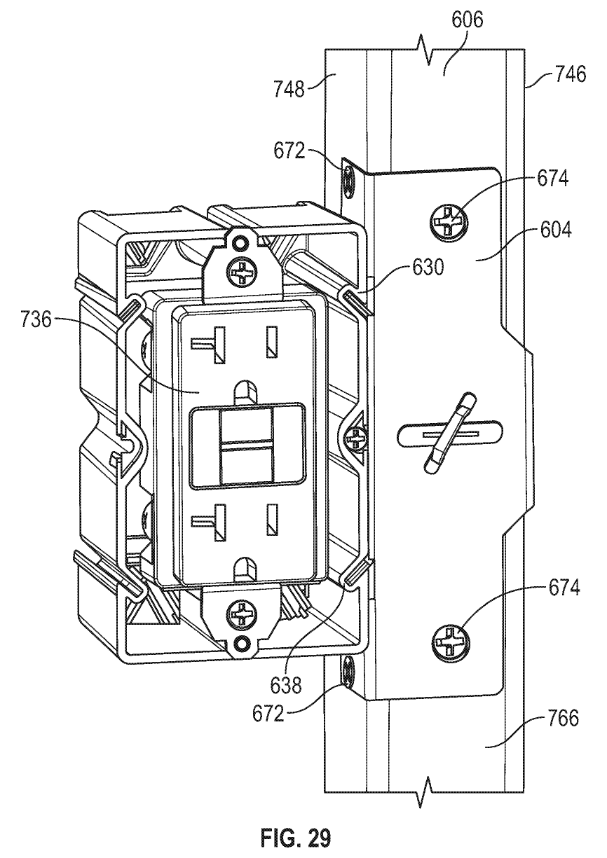

FIG. 29 illustrates the junction box 602 secured to the side wall 746 of the wall stud, demonstrating the complete installation configuration. As discussed above, the junction box 602 can be easily secured to the left or right side of the wall stud 606 without requiring modification of the electrical device 736 orientation, providing installation flexibility and reducing the complexity of field installation procedures. The electrical device 736 in this example is shown in a vertical orientation, in which an elongate section of the electrical device 736 is vertical relative to the stud 606. In other examples, the electrical device 736 (e.g., and junction box 602) can be installed in any orientation, such as horizontal.

In some implementations, devices or systems disclosed herein can be utilized, manufactured, installed, etc. using methods embodying aspects of the disclosed technology. Correspondingly, any description herein of particular features, capabilities, or intended purposes of a device or system should be considered to disclose, as examples of the disclosed technology a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, should be understood to disclose, as examples of the disclosed technology, the utilized features and implemented capabilities of such device or system.

For example, a method of installing an electrical assembly to a wall stud may include providing a junction box, a mounting bracket, and an electrical device secured to the junction box in a first orientation (e.g., as shown in either of FIGS. 21 and 29). The mounting bracket may be selectively secured to extend along either the first side of the wall stud (see, e.g., the right side wall 746 in FIG. 21) or the second side of the wall stud (see, e.g., the left side wall 748 in FIG. 29). With the electrical device in the first orientation and without removing the electrical device from the junction box, the junction box may be selectively supported on the mounting bracket with the electrical device slidingly engaged with the first side of the junction box along the first side of the wall stud when the mounting bracket is secured to extend along the first side of the wall stud (see, e.g., FIG. 21), or with the second side of the junction box along the second side of the wall stud when the mounting bracket is secured to extend along the second side of the wall stud (see, e.g., FIG. 29).

A depth of the junction box relative to the mounting bracket may be adjusted to adjust a depth of junction box and the electrical device relative to the wall stud. Further, as shown in FIGS. 21 and 29, the electrical device 736 maintains the same orientation within the junction box 602 in both installed configurations, demonstrating the reversible mounting capability without requiring removal or reorientation of the electrical device 736.

In some implementations, after the mounting bracket has been secured to extend along the first side of the wall stud or the second side of the wall stud, and after the junction box has been selectively supported on the mounting bracket along the first side of the wall stud or the second side of the wall stud, the method may further include, without removing the electrical device from the junction box, slidably disengaging the junction box from the mounting bracket at the first side of the junction box or at the second side of the junction box, respectively. The mounting bracket may then be secured to extend along the second side of the wall stud or the first side of the wall stud, respectively. With the electrical device in the first orientation, the junction box may be slidably engaged to the mounting bracket at the second side of the junction box along the second side of the wall stud, or at the first side of the junction box along the first side of the wall stud, respectively (i.e., to switch the junction box to the opposing side of the stud, without removing or reorienting the electrical device).

In some embodiments, the junction box may include an open back and a back cover that is removably coupled to the junction box to cover the open back. The method may correspondingly further include connecting an electrical device of the electrical assembly to a building electrical system by accessing the electrical device through the open back of the junction box. After connecting the electrical device to the building electrical system, the open back may be closed with the back cover.

In some examples, the selective securing of the mounting bracket to extend along the first side of the wall stud or the second side of the wall stud may include urging (e.g., pressing or driving) the mounting bracket into engagement with the wall stud so that an anchor wall of the mounting bracket engages an opposite side of the wall stud from the junction box, and an adjustment wall of the mounting bracket extends along the same side of the wall stud as the junction box, with the adjustment wall slidably engaging the junction box. In some cases, the anchor wall may be shorter than the adjustment wall and may include a barb configured to engage the wall stud.

The adjusting of the depth of the junction box relative to the mounting bracket may include rotating an adjustment screw that engages threads on the adjustment wall of the mounting bracket. In some implementations, the threads may be defined by slots formed in the adjustment wall. The adjustment screw may include a head that is retained by a snap-engagement relative to the junction box to allow retained rotation of the adjustment screw.

In another embodiment, a method of installing an electrical assembly to a wall stud may include accessing the electrical assembly, including a mounting bracket secured to a wall stud in a first orientation, a junction box secured to the mounting bracket along a first side of a wall stud, and an electrical device secured to the junction box in a first orientation (e.g., as shown in FIG. 21). The junction box may include a first side and a second side opposite the first side. Without removing the electrical device from the junction box and without reorienting the electrical device relative to the junction box, the method may include removing the junction box from the mounting bracket, removing the mounting bracket from the wall stud, reattaching the mounting bracket to the wall stud in a second orientation different from the first orientation, and installing the junction box to the mounting bracket with the electrical device in the first orientation on a second side of the wall stud opposite the first side (e.g., as shown in FIG. 29). After installing the junction box to the mounting bracket with the electrical device on the second side of the wall stud, a depth of the junction box relative to the mounting bracket may be adjusted to adjust a depth of the junction box and the electrical device relative to the wall stud.

The method may further include, after installing the junction box to the mounting bracket with the electrical device on the second side of the wall stud, accessing the electrical device through an open back of the junction box to connect the electrical device to a building electrical system. The open back may be closed with a back cover after connecting the electrical device to the building electrical system. In some cases, the adjusting of the depth of the junction box may include adjusting a screw that is retained on the junction box to engage a set of angled slots on the mounting bracket. The back cover may be a hinged cover, and closing the open back may include rotating the back cover to a closed orientation.

In particular examples, the disclosed technology can be used to temporarily mount the junction box with the rear face orientated forward (i.e., facing the interior of the room, with the example of FIG. 21 considered as alternatively showing a rear side of the stud). For example, on exterior walls, once the box is permanently mounted, the rear becomes completely inaccessible due to sheathing, insulation, etc. In tight or adjacent finished spaces, physical access to the rear of a mounted box may also (or alternatively) be blocked. And, electricians may prefer to wire from the same side they mounted the box to avoid walking around, or through the framed wall. In this regard, dual-side guide features (e.g., as detailed above) make it possible to temporarily mount the junction box with the rear face forward, enabling full wiring access in these scenarios. In contrast, without dual-side guide features, an electrician may need to complete all wiring before mounting the box, remove the device from the front of the box to access the wiring compartment, or rotate the adjustment screw until the box disengages from the bracket, then wire the unsupported box – each causing potential increases in time or complexity of installation procedures.

Moreover, completing the wiring for a device can be significantly easier when the box is secured, even temporarily, rather than attempting to wire a box that is floating or suspended by cables. Correspondingly, a temporarily mounted box provides stability, improves visibility, and reduces the risk of miswiring.

Thus, embodiments of the disclosure provide for an improved mounting assembly and corresponding methods. In some embodiments, for example, a mounting bracket can be easily removed and selectively secured to a junction box on either a left or a right side of the junction box and, correspondingly, selectively secured to a left or a right side of a wall stud. In some embodiments, the junction box can include a back cover that can be removably coupled to the junction box (e.g., to provide easy access to electrical devices after installation of the assembly on a stud, without removal of the electrical devices).

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

For convenience of presentation, in some figures that include multiple instances of similar features, only some of the similar features may be specifically indicated by reference number. One of skill in the art will recognize that the features not labeled with reference numbers can include similar aspects and perform similar functions to similar features that are labeled with reference numbers. Similarly, some features may be labeled with reference numbers in only select figures.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

Also as used herein, unless otherwise limited or defined, “integral” and derivatives thereof (e.g., “integrally”) describe elements that are manufactured as a single piece without fasteners, adhesive, or the like to secure separate components together. For example, an element that is stamped, cast, or otherwise molded as a single-piece component from a single piece of sheet metal or other continuous single piece of material, without rivets, screw 150s, other fasteners, or adhesive to hold separately formed pieces together, is an integral (and integrally formed) element. In contrast, an element formed from multiple pieces that are separately formed initially then later fastened together, is not an integral (or integrally formed) element.

As used herein, unless otherwise limited or specified, “substantially identical” refers to two or more components or systems that are manufactured according to the same process and specification, with variation between the components or systems that are within the limitations of acceptable tolerances for the relevant process or specification. For example, two components can be considered to be substantially identical if the components are manufactured according to the same standardized manufacturing steps, with the same materials, and within the same acceptable dimensional tolerances (e.g., as specified for a particular process or product).

Unless otherwise specified or limited, the terms “about” and “approximately,” as used herein with respect to a reference value, refer to variations from the reference value of ± 20% or less (e.g., ± 15, ± 10%, ± 5%, etc.), inclusive of the endpoints of the range. Similarly, as used herein with respect to a reference value, the term “substantially equal” (and the like) refers to variations from the reference value of ± 5% or less (e.g., ± 2%, ± 1%, ± 0.5%) inclusive. Where specified in particular, “substantially” can indicate a variation in one numerical direction relative to a reference value. In particular, the term “substantially less” than a reference value (and the like) indicates a value that is reduced from the reference value by 30% or more (e.g., 35%, 40%, 50%, 65%, 80%), and the term “substantially more” than a reference value (and the like) indicates a value that is increased from the reference value by 30% or more (e.g., 35%, 40%, 50%, 65%, 80%).

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order. Relatedly, similar or identical components may be referred to with different ordinal numbers in different contexts.

Also as used herein, unless otherwise defined or limited, directional terms are used for convenience of reference for discussion of particular figures or examples or to indicate spatial relationships relative to particular other components or context, but are not intended to indicate absolute orientation. For example, references to downward, forward, or other directions, or to top, rear, or other positions (or features) may be used to discuss aspects of a particular example or figure, but do not necessarily require similar orientation or geometry in all installations or configurations.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A method of installing an electrical assembly to a wall stud that defines a front face, a rear face, a first side extending between the front face and the rear face, and a second side extending between the front face and the rear face, the method comprising:
providing the electrical assembly, including a junction box, a mounting bracket, and an electrical device secured to the junction box in a first orientation, the junction box defining a front, a rear, a top, a bottom, a first side extending from the front to the rear between the top and the bottom, and a second side extending from the front to the rear between the top and the bottom;
selectively securing the mounting bracket to extend along either the first side of the wall stud or the second side of the wall stud; and
with the electrical device in the first orientation and without removing the electrical device from the junction box, selectively supporting the junction box on the mounting bracket with the electrical device slidingly engaged with:
the first side of the junction box, along the first side of the wall stud, with the mounting bracket secured to extend along the first side of the wall stud; or
the second side of the junction box, along the second side of the wall stud, with the mounting bracket secured to extend along the second side of the wall stud; and
adjusting a depth of the junction box relative to the mounting bracket to adjust a depth of junction box and the electrical device relative to the wall stud.

2. The method of claim 1, further comprising, after selectively securing of the mounting bracket to extend along the first side of the wall stud or the second side of the wall stud, after selectively supporting the junction box on the mounting bracket along the first side of the wall stud or the second side of the wall stud, and without removing the electrical device from the junction box:
slidably disengaging the junction box from the mounting bracket at the first side of the junction box or at the second side of the junction box, respectively;
securing the mounting bracket to extend along the second side of the wall stud or the first side of the wall stud, respectively; and
with the electrical device in the first orientation, slidably engaging the junction box to the mounting bracket at, respectively:
the second side of the junction box, along the second side of the wall stud; or
the first side of the junction box, along the first side of the wall stud.

3. The method of claim 1, wherein the junction box includes an open back and a back cover that is removably or hingedly coupled to the junction box to cover the open back; and
wherein the method further comprises:
connecting an electrical device of the electrical assembly to a building electrical system by accessing the electrical device through an open back of the junction box; and
after connecting the electrical device to the building electrical system, closing the open back with a back cover.

4. The method of claim 1, wherein selectively securing the mounting bracket to extend along the first side of the wall stud or the second side of the wall stud includes urging the mounting bracket into engagement with the wall stud so that:
an anchor wall of the mounting bracket engages an opposite side of the wall stud from the junction box; and
an adjustment wall of the mounting bracket extends along the same side of the wall stud as the junction box, with the adjustment wall slidably engaging the junction box.

5. The method of claim 4, wherein the anchor wall is shorter than the adjustment wall and includes a barb configured to engage the wall stud.

6. The method of claim 4, wherein adjusting the depth of the junction box relative to the mounting bracket includes rotating an adjustment screw that engages threads on the adjustment wall of the mounting bracket.

7. The method of claim 6, wherein the threads are defined by slots formed in the adjustment wall.

8. The method of claim 6, wherein the adjustment screw includes a head that is retained by a snap-engagement relative to the junction box.

9. A method of installing an electrical assembly to a wall stud, the method comprising:
accessing the electrical assembly including a mounting bracket secured to a wall stud in a first orientation, a junction box secured to the mounting bracket along a first side of a wall stud, and an electrical device secured to the junction box in a first orientation, the junction box including a first side, and a second side opposite the first side;
without removing the electrical device from the junction box and without reorienting the electrical device relative to the junction box:
removing the junction box from the mounting bracket;
removing the mounting bracket from the wall stud;
reattaching the mounting bracket to the wall stud in a second orientation, different from the first orientation; and
installing the junction box to the mounting bracket, with the electrical device in the first orientation on a second side of the wall stud opposite the first side; and
after installing the junction box to the mounting bracket with the electrical device on the second side of the wall stud, adjusting a depth of the junction box relative to the mounting bracket to adjust a depth of the junction box and the electrical device relative to the wall stud.

10. The method of claim 9, further comprising:
after installing the junction box to the mounting bracket with the electrical device on the second side of the wall stud, accessing the electrical device through an open back of the junction box to connect the electrical device to a building electrical system.

11. The method of claim 10, further comprising:
closing the open back with a back cover, after connecting the electrical device to the building electrical system.

12. The method of claim 9, wherein adjusting the depth of the junction box includes adjusting a screw that is retained on the junction box to engage a set of angled slots on the mounting bracket.

13. The method of claim 11, wherein the back cover is a hinged cover, and closing the open back includes rotating the back cover to a closed orientation.

14. An electrical assembly for a wall stud, the electrical assembly comprising:
a junction box having an open back and defining a front, a rear, a top, a bottom, a first side extending from the front to the rear between the top and the bottom, and a second side extending from the front to the rear between the top and the bottom;
an electrical device secured to the junction box in a first orientation; and
a mounting bracket that is selectively securable to the wall stud to extend along a first side of the wall stud or a second side of the wall stud, to selectively support the junction box at the first side of the junction box or the second side of the junction box, with the junction box selectively on a first side of a wall stud or a second side of the wall stud, respectively, the electrical device in the first orientation, and the mounting bracket slidingly engaged with the junction box for depth adjustment of the junction box relative to the mounting bracket to adjust a depth of junction box and the electrical device relative to the wall stud.

15. The electrical assembly of claim 14, wherein the junction box includes first grooves on the first side and second grooves on the second side that are selectively engageable by the mounting bracket to mount the junction box on the first side of the wall stud or the second side of the wall stud, respectively, without removal or reorientation of the electrical device relative to the junction box.

16. The electrical assembly of claim 15, wherein the first grooves include a first upper groove and a first lower groove and the second grooves include a second upper groove and a second lower groove;
wherein the mounting bracket includes a plurality of first tabs and a plurality of second tabs;
wherein, to slidingly support the junction box on the first side of the wall stud, the plurality of first tabs are receivable in the first upper groove and the plurality of second tabs are receivable in the first lower groove; and
wherein, to slidingly support the junction box on the second side of the wall stud, the plurality of first tabs are receivable in the second lower groove and plurality of second tabs are receivable in the second upper groove.

17. The electrical assembly of claim 14, further comprising:
a threaded fastener engageable with threaded features on the mounting bracket to adjust the depth of the junction box.

18. The electrical assembly of claim 17, wherein the threaded features include angled slots.

19. The electrical assembly of claim 14, further comprising:
a removable back cover configured to cover an open back of the junction box.

20. The electrical assembly of claim 19, wherein the removable back cover is hingedly coupled to the junction box with one or more hinge clips secured to the junction box.
